(19) United States
(12) Patent Application Publication
(10) Pub. No.: US 2022/0201308 A1
(43) Pub. Date: Jun. 23, 2022

(54) MEDIA FILE PROCESSING METHOD AND DEVICE THEREFOR

(71) Applicant: LG ELECTRONICS INC., Seoul (KR)

(72) Inventor: Hendry HENDRY, Seoul (KR)

(21) Appl. No.: 17/552,035

(22) Filed: Dec. 15, 2021

Related U.S. Application Data
(60) Provisional application No. 63/127,977, filed on Dec. 18, 2020.

(51) Int. Cl. H04N 19/132; H04N 19/105; H04N 19/169; H04N 19/176

(52) U.S. Cl. CPC H04N 19/132; H04N 19/176; H04N 19/188; H04N 19/105

(57) ABSTRACT

A method for generating a media file according to the present disclosure is characterized by including: a step of configuring a sample entry and samples for a subpicture track; a step of generating the subpicture track including the sample entry and the samples; and a step of generating the media file including the subpicture track, wherein a sample entry type of the sample entry is one of a ‘vvs1’, a ‘vvc1’or a ‘vvi1’, and wherein the sample entry and the samples in the subpicture track are configured without non-video coding layer (non-VCL) network abstraction layer (NAL) units.

### CROSS-REFERENCE TO RELATED APPLICATIONS

Pursuant to 35 U.S.C. § 119(e), this application claims the benefit of U.S. Provisional Application No. 63/127,977, filed on Dec. 18, 2020, the contents of which are all hereby incorporated by reference herein in their entirety.

### BACKGROUND OF THE DISCLOSURE

### Field of the disclosure

The present disclosure relates to a video/image coding technology, and more particularly, to a method for processing a media file for image information coded in a video/image coding system and an apparatus therefor.

### Related Art

Recently, the demand for high resolution, high quality image/video such as 4K, 8K or more Ultra High Definition (UHD) video/image is increasing in various fields. As the video/image resolution or quality becomes higher, relatively more amount of information or bits are transmitted than for conventional video/image data. Therefore, if video/image data are transmitted via a medium such as an existing wired/wireless broadband line or stored in a legacy storage medium, costs for transmission and storage are readily increased.

Moreover, interests and demand are growing for virtual reality (VR) and artificial reality (AR) contents, and immersive media such as hologram; and broadcasting of images/videos exhibiting image/video characteristics different from those of an actual video/image, such as game images/videos, are also growing.

Therefore, a highly efficient image compression technique is required to effectively compress and transmit, store, or play high resolution, high quality video/image showing various characteristics as described above.

### SUMMARY

The present disclosure provides a method and an apparatus for increasing video/image coding efficiency.

The present disclosure also provides a method and an apparatus for generating a media file for coded image information.

The present disclosure also provides a method and an apparatus for processing the media file for the coded image information.

In an aspect, a method for generating a media file, which is performed by an apparatus for generating a media file is provided. The method for generating a media file includes: configuring a sample entry and samples for a subpicture track; generating the subpicture track comprising the sample entry and the samples; and generating the media file comprising the subpicture track, in which a sample entry type of the sample entry is one of a ‘vvs1’, a ‘vvc1’ or a ‘vvil’, and the sample entry and the samples in the subpicture track are configured without non-video coding layer (non-VCL) network abstraction layer (NAL) units.

In another aspect, an apparatus for generating a media file is provided. The apparatus for generating a media file includes: an image processor configuring a sample entry and samples for a subpicture track, and generating the subpicture track comprising the sample entry and the samples; and a media file generator generating the media file comprising the subpicture track, in which a sample entry type of the sample entry is one of a ‘vvs1’, a ‘vvc1’ or a ‘vvil’, and the sample entry and the samples in the subpicture track are configured without non-video coding layer (non-VCL) network abstraction layer (NAL) units.

In yet another aspect, a method for processing a media file, which is performed by an apparatus for processing a media file, is provided. A method for generating a media file according to the present disclosure includes: obtaining the media file comprising a subpicture track comprising a sample entry and samples; parsing the subpicture track; and parsing the sample entry and the samples for the subpicture track, in which a sample entry type of the sample entry is one of a ‘vvs1’, a ‘vvc1’ or a ‘vvi1’, and the sample entry and the samples in the subpicture track are configured without non-video coding layer (non-VCL) network abstraction layer (NAL) units.

In still yet another aspect, an apparatus for processing a media file is provided. The apparatus for processing a media file includes: a receiver obtaining the media file comprising a subpicture track comprising a sample entry and samples; parsing the subpicture track; and a media file processor parsing the sample entry and the samples for the subpicture track, in which a sample entry type of the sample entry is one of a ‘vvs1’, a ‘vvc1’ or a ‘vvi1’, and the sample entry and the samples in the subpicture track are configured without non-video coding layer (non-VCL) network abstraction layer (NAL) units.

In still yet another aspect, a computer readable digital storage medium storing a media file generated by a method for generating a media file is provided. In the computer readable digital storage medium, the method includes: configuring a sample entry and samples for a subpicture track; generating the subpicture track comprising the sample entry and the samples; and generating the media file comprising the subpicture track, in which a sample entry type of the sample entry is one of a ‘vvs1’, a ‘vvc1’ or a ‘vvi1’, and the sample entry and the samples in the subpicture track are configured without non-video coding layer (non-VCL) network abstraction layer (NAL) units.

According to the present disclosure, a subpicture track includes a sample entry and samples, and a sample entry type of the sample entry is one of ‘vvs1’, ‘vvc1’, or ‘vvi1’, and the sample entry and the samples of the subpicture track are configured without non-video coding layer (non-VCL) network abstraction layer (NAL) units. The non-VCL NAL unit is configured not to exist in the samples of the sample entry and the subpicture track regardless of the type of the sample entry in the subpicture track through this to implement a parser without considering the sample entry type in the subpicture track, thereby reducing complexity and increasing a processing speed.

### BRIEF DESCRIPTION OF THE DRAWINGS

FIG. 1 schematically illustrates an example of a video/image coding system to which embodiments of this document are applicable.

FIG. 2 is a schematic diagram illustrating a configuration of a video/image encoding apparatus to which the embodiment(s) of the present disclosure may be applied.

FIG. 3 is a schematic diagram illustrating a configuration of a video/image decoding apparatus to which the embodiment(s) of the present disclosure may be applied.

FIG. 4 exemplarily illustrates a layer structure for a coded video/image.

FIGS. 5 and 6 schematically illustrate an example of a media file structure.

FIG. 7 illustrates an example of the overall operation of a DASH-based adaptive streaming model.

FIG. 8 schematically illustrates a method for generating VVC subpicture tracks.

FIG. 9 exemplarily illustrates a method for generating a media file to which an embodiment proposed in the present disclosure is applied.

FIG. 10 exemplarily illustrates a method for decoding a media file generated by applying the embodiment proposed in the present disclosure.

FIG. 11 schematically illustrates a method for generating a media file by an apparatus for generating a media file according to the present disclosure.

FIG. 12 schematically illustrates an apparatus for generating a media file, which performs a method for generating a media file according to the present disclosure.

FIG. 13 schematically illustrates a method for processing a media file by an apparatus for processing a media file according to the present disclosure.

FIG. 14 schematically illustrates an apparatus for processing a media file, which performs a method for processing a media file according to the present disclosure.

FIG. 15 illustrates a structural diagram of a contents streaming system to which the present disclosure is applied.

### DESCRIPTION OF EXEMPLARY EMBODIMENTS

The present disclosure may be modified in various forms, and specific embodiments thereof will be described and illustrated in the drawings. However, the embodiments are not intended for limiting the disclosure. The terms used in the following description are used to merely describe specific embodiments but are not intended to limit the disclosure. An expression of a singular number includes an expression of the plural number, so long as it is clearly read differently. The terms such as “include” and “have” are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

Meanwhile, elements in the drawings described in the disclosure are independently drawn for the purpose of convenience for explanation of different specific functions, and do not mean that the elements are embodied by independent hardware or independent software. For example, two or more elements of the elements may be combined to form a single element, or one element may be partitioned into plural elements. The embodiments in which the elements are combined and/or partitioned belong to the disclosure without departing from the concept of the disclosure.

Hereinafter, embodiments of the present disclosure will be described in detail with reference to the accompanying drawings. In addition, like reference numerals may be used to indicate like elements throughout the drawings, and the same descriptions on the like elements will be omitted.

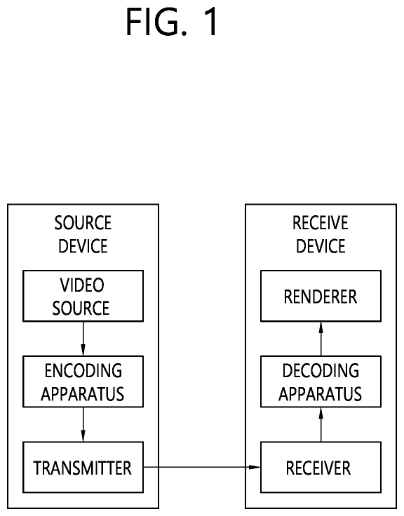

FIG. 1 schematically illustrates an example of a video/image coding system to which the embodiments of the present document may be applied.

Referring to FIG. 1, a video/image coding system may include a first device (source device) and a second device (receiving device). The source device may deliver encoded video/image information or data in the form of a file or streaming to the receiving device via a digital storage medium or network.

The source device may include a video source, an encoding apparatus, and a transmitter. The receiving device may include a receiver, a decoding apparatus, and a renderer. The encoding apparatus may be called a video/image encoding apparatus, and the decoding apparatus may be called a video/image decoding apparatus. The transmitter may be included in the encoding apparatus. The receiver may be included in the decoding apparatus. The renderer may include a display, and the display may be configured as a separate device or an external component.

The video source may acquire video/image through a process of capturing, synthesizing, or generating the video/image. The video source may include a video/image capture device and/or a video/image generating device. The video/image capture device may include, for example, one or more cameras, video/image archives including previously captured video/images, and the like. The video/image generating device may include, for example, computers, tablets and smartphones, and may (electronically) generate video/images. For example, a virtual video/image may be generated through a computer or the like. In this case, the video/image capturing process may be replaced by a process of generating related data.

The encoding apparatus may encode input image/image. The encoding apparatus may perform a series of procedures such as prediction, transform, and quantization for compression and coding efficiency. The encoded data (encoded video/image information) may be output in the form of a bitstream.

The transmitter may transmit the encoded image/image information or data output in the form of a bitstream to the receiver of the receiving device through a digital storage medium or a network in the form of a file or streaming. The digital storage medium may include various storage mediums such as USB, SD, CD, DVD, Blu-ray, HDD, SSD, and the like. The transmitter may include an element for generating a media file through a predetermined file format and may include an element for transmission through a broadcast/communication network. The receiver may receive/extract the bitstream and transmit the received bitstream to the decoding apparatus.

The decoding apparatus may decode the video/image by performing a series of procedures such as dequantization, inverse transform, and prediction corresponding to the operation of the encoding apparatus.

The renderer may render the decoded video/image. The rendered video/image may be displayed through the display.

Present disclosure relates to video/image coding. For example, the methods/embodiments disclosed in the present disclosure may be applied to a method disclosed in the versatile video coding (VVC) standard, the essential video coding (EVC) standard, the AOMedia Video 1 (AV1) standard, the 2nd generation of audio video coding standard (AVS2), or the next generation video/image coding standard (ex. H.267 or H.268, etc.).

Present disclosure presents various embodiments of video/image coding, and the embodiments may be performed in combination with each other unless otherwise mentioned.

In the present disclosure, video may refer to a series of images over time. Picture generally refers to a unit representing one image in a specific time zone, and a subpicture/slice/tile is a unit constituting part of a picture in coding. The subpicture/slice/tile may include one or more coding tree units (CTUs). One picture may consist of one or more subpictures/slices/tiles. One picture may consist of one or more tile groups. One tile group may include one or more tiles. A brick may represent a rectangular region of CTU rows within a tile in a picture. A tile may be partitioned into multiple bricks, each of which consisting of one or more CTU rows within the tile. A tile that is not partitioned into multiple bricks may be also referred to as a brick. A brick scan is a specific sequential ordering of CTUs partitioning a picture in which the CTUs are ordered consecutively in CTU raster scan in a brick, bricks within a tile are ordered consecutively in a raster scan of the bricks of the tile, and tiles in a picture are ordered consecutively in a raster scan of the tiles of the picture. Also, a subpicture may represent a rectangular region of one or more slices within a picture. That is, a subpicture may contain one or more slices that collectively cover a rectangular region of a picture. A tile is a rectangular region of CTUs within a particular tile column and a particular tile row in a picture. The tile column is a rectangular region of CTUs having a height equal to the height of the picture and a width specified by syntax elements in the picture parameter set. The tile row is a rectangular region of CTUs having a height specified by syntax elements in the picture parameter set and a width equal to the width of the picture. A tile scan is a specific sequential ordering of CTUs partitioning a picture in which the CTUs are ordered consecutively in CTU raster scan in a tile whereas tiles in a picture are ordered consecutively in a raster scan of the tiles of the picture. A slice includes an integer number of bricks of a picture that may be exclusively contained in a single NAL unit. A slice may consist of either a number of complete tiles or only a consecutive sequence of complete bricks of one tile. Tile groups and slices may be used interchangeably in the present disclosure. For example, in the present disclosure, a tile group/tile group header may be called a slice/slice header.

A pixel or a pel may mean a smallest unit constituting one picture (or image). Also, ‘sample’ may be used as a term corresponding to a pixel. A sample may generally represent a pixel or a value of a pixel, and may represent only a pixel/pixel value of a luma component or only a pixel/pixel value of a chroma component.

A unit may represent a basic unit of image processing. The unit may include at least one of a specific region of the picture and information related to the region. One unit may include one luma block and two chroma (ex. cb, cr) blocks. The unit may be used interchangeably with terms such as block or area in some cases. In a general case, an M×N block may include samples (or sample arrays) or a set (or array) of transform coefficients of M columns and N rows.

In the present disclosure, “A or B” may mean “only A”, “only B” or “both A and B”. In other words, in the present disclosure, “A or B” may be interpreted as “A and/or B”. For example, in the present disclosure, “A, B or C” may mean “only A”, “only B”, “only C”, or “any combination of A, B and C”.

A slash (/) or a comma used in the present disclosure may mean “and/or”. For example, “A/B” may mean “A and/or B”. Accordingly, “A/B” may mean “only A”, “only B”, or “both A and B”. For example, “A, B, C” may mean “A, B, or C”.

In the present disclosure, “at least one of A and B” may mean “only A”, “only B” or “both A and B”. Also, in the present disclosure, the expression “at least one of A or B” or “at least one of A and/or B” may be interpreted the same as “at least one of A and B”.

Also, in the present disclosure, “at least one of A, B and C” may mean “only A”, “only B”, “only C”, or “any combination of A, B and C”. Also, “at least one of A, B or C” or “at least one of A, B and/or C” may mean “at least one of A, B and C”.

In addition, parentheses used in the present disclosure may mean “for example”. Specifically, when “prediction (intra prediction)” is indicated, “intra prediction” may be proposed as an example of “prediction”. In other words, “prediction” in the present disclosure may be not limited to “intra prediction”, and “intra prediction” may be proposed as an example of “prediction”. Also, even when “prediction (i.e., intra prediction)” is indicated, “intra prediction” may be proposed as an example of “prediction”.

Technical features that are individually described in one drawing in the present disclosure may be implemented individually or may be implemented at the same time.

The following drawings were created to explain a specific example of the present disclosure. Since the names of specific devices described in the drawings or the names of specific signals/messages/fields are presented as an example, the technical features of the present disclosure are not limited to the specific names used in the following drawings.

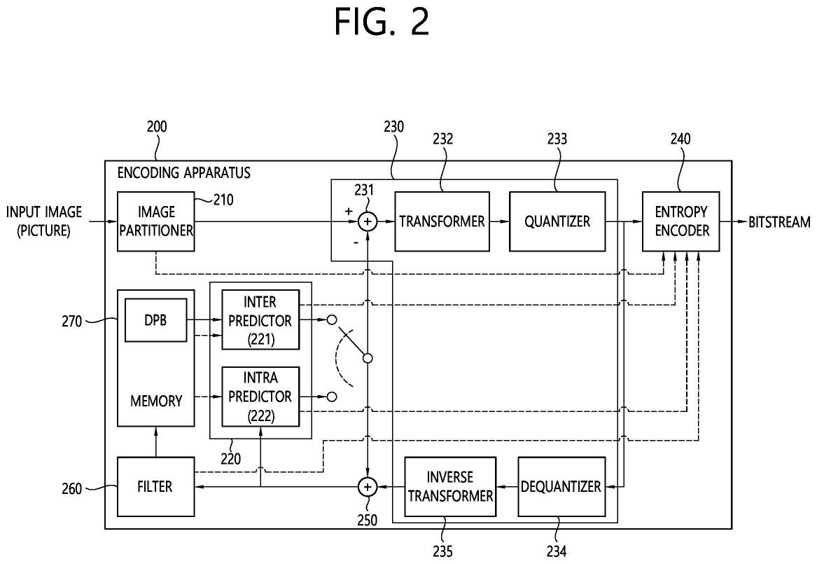

FIG. 2 is a schematic diagram illustrating a configuration of a video/image encoding apparatus to which the embodiment(s) of the present disclosure may be applied. Hereinafter, the video encoding apparatus may include an image encoding apparatus.

Referring to FIG. 2, the encoding apparatus 200 includes an image partitioner 210, a predictor 220, a residual processor 230, and an entropy encoder 240, an adder 250, a filter 260, and a memory 270. The predictor 220 may include an inter predictor 221 and an intra predictor 222. The residual processor 230 may include a transformer 232, a quantizer 233, a dequantizer 234, and an inverse transformer 235. The residual processor 230 may further include a subtractor 231. The adder 250 may be called a reconstructor or a reconstructed block generator. The image partitioner 210, the predictor 220, the residual processor 230, the entropy encoder 240, the adder 250, and the filter 260 may be configured by at least one hardware component (ex. An encoder chipset or processor) according to an embodiment. In addition, the memory 270 may include a decoded picture buffer (DPB) or may be configured by a digital storage medium. The hardware component may further include the memory 270 as an internal/external component.

The image partitioner 210 may partition an input image (or a picture or a frame) input to the encoding apparatus 200 into one or more processors. For example, the processor may be called a coding unit (CU). In this case, the coding unit may be recursively partitioned according to a quad-tree binary-tree ternary-tree (QTBTTT) structure from a coding tree unit (CTU) or a largest coding unit (LCU). For example, one coding unit may be partitioned into a plurality of coding units of a deeper depth based on a quad tree structure, a binary tree structure, and/or a ternary structure. In this case, for example, the quad tree structure may be applied first and the binary tree structure and/or ternary structure may be applied later. Alternatively, the binary tree structure may be applied first. The coding procedure according to the present disclosure may be performed based on the final coding unit that is no longer partitioned. In this case, the largest coding unit may be used as the final coding unit based on coding efficiency according to image characteristics, or if necessary, the coding unit may be recursively partitioned into coding units of deeper depth and a coding unit having an optimal size may be used as the final coding unit. Here, the coding procedure may include a procedure of prediction, transform, and reconstruction, which will be described later. As another example, the processor may further include a prediction unit (PU) or a transform unit (TU). In this case, the prediction unit and the transform unit may be split or partitioned from the aforementioned final coding unit. The prediction unit may be a unit of sample prediction, and the transform unit may be a unit for deriving a transform coefficient and/or a unit for deriving a residual signal from the transform coefficient.

The unit may be used interchangeably with terms such as block or area in some cases. In a general case, an M×N block may represent a set of samples or transform coefficients composed of M columns and N rows. A sample may generally represent a pixel or a value of a pixel, may represent only a pixel/pixel value of a luma component or represent only a pixel/pixel value of a chroma component. A sample may be used as a term corresponding to one picture (or image) for a pixel or a pel.

In the encoding apparatus 200, a prediction signal (predicted block, prediction sample array) output from the inter predictor 221 or the intra predictor 222 is subtracted from an input image signal (original block, original sample array) to generate a residual signal residual block, residual sample array), and the generated residual signal is transmitted to the transformer 232. In this case, as shown, a unit for subtracting a prediction signal (predicted block, prediction sample array) from the input image signal (original block, original sample array) in the encoder 200 may be called a subtractor 231. The predictor may perform prediction on a block to be processed (hereinafter, referred to as a current block) and generate a predicted block including prediction samples for the current block. The predictor may determine whether intra prediction or inter prediction is applied on a current block or CU basis. As described later in the description of each prediction mode, the predictor may generate various information related to prediction, such as prediction mode information, and transmit the generated information to the entropy encoder 240. The information on the prediction may be encoded in the entropy encoder 240 and output in the form of a bitstream.

The intra predictor 222 may predict the current block by referring to the samples in the current picture. The referred samples may be located in the neighborhood of the current block or may be located apart according to the prediction mode. In the intra prediction, prediction modes may include a plurality of non-directional modes and a plurality of directional modes. The non-directional mode may include, for example, a DC mode and a planar mode. The directional mode may include, for example, 33 directional prediction modes or 65 directional prediction modes according to the degree of detail of the prediction direction. However, this is merely an example, more or less directional prediction modes may be used depending on a setting. The intra predictor 222 may determine the prediction mode applied to the current block by using a prediction mode applied to a neighboring block.

The inter predictor 221 may derive a predicted block for the current block based on a reference block (reference sample array) specified by a motion vector on a reference picture.

Here, in order to reduce the amount of motion information transmitted in the inter prediction mode, the motion information may be predicted in units of blocks, sub-blocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. The reference picture including the reference block and the reference picture including the temporal neighboring block may be the same or different. The temporal neighboring block may be called a collocated reference block, a co-located CU (colCU), and the like, and the reference picture including the temporal neighboring block may be called a collocated picture (colPic). For example, the inter predictor 221 may configure a motion information candidate list based on neighboring blocks and generate information indicating which candidate is used to derive a motion vector and/or a reference picture index of the current block. Inter prediction may be performed based on various prediction modes.

For example, in the case of a skip mode and a merge mode, the inter predictor 221 may use motion information of the neighboring block as motion information of the current block. In the skip mode, unlike the merge mode, the residual signal may not be transmitted. In the case of the motion vector prediction (MVP) mode, the motion vector of the neighboring block may be used as a motion vector predictor and the motion vector of the current block may be indicated by signaling a motion vector difference.

The predictor 220 may generate a prediction signal based on various prediction methods described below. For example, the predictor may not only apply intra prediction or inter prediction to predict one block but also simultaneously apply both intra prediction and inter prediction. This may be called combined inter and intra prediction (CIIP). In addition, the predictor may be based on an intra block copy (IBC) prediction mode or a palette mode for prediction of a block. The IBC prediction mode or palette mode may be used for content image/video coding of a game or the like, for example, screen content coding (SCC). The IBC basically performs prediction in the current picture but may be performed similarly to inter prediction in that a reference block is derived in the current picture. That is, the IBC may use at least one of the inter prediction techniques described in the present disclosure. The palette mode may be considered as an example of intra coding or intra prediction. When the palette mode is applied, a sample value within a picture may be signaled based on information on the palette table and the palette index.

The prediction signal generated by the predictor (including the inter predictor 221 and/or the intra predictor 222) may be used to generate a reconstructed signal or to generate a residual signal. The transformer 232 may generate transform coefficients by applying a transform technique to the residual signal. For example, the transform technique may include at least one of a discrete cosine transform (DCT), a discrete sine transform (DST), a karhunen-loève transform (KLT), a graph-based transform (GBT), or a conditionally non-linear transform (CNT). Here, the GBT means transform obtained from a graph when relationship information between pixels is represented by the graph. The CNT refers to transform generated based on a prediction signal generated using all previously reconstructed pixels. In addition, the transform process may be applied to square pixel blocks having the same size or may be applied to blocks having a variable size rather than square.

The quantizer 233 may quantize the transform coefficients and transmit them to the entropy encoder 240 and the entropy encoder 240 may encode the quantized signal (information on the quantized transform coefficients) and output a bitstream. The information on the quantized transform coefficients may be referred to as residual information. The quantizer 233 may rearrange block type quantized transform coefficients into a one-dimensional vector form based on a coefficient scanning order and generate information on the quantized transform coefficients based on the quantized transform coefficients in the one-dimensional vector form. Information on transform coefficients may be generated. The entropy encoder 240 may perform various encoding methods such as, for example, exponential Golomb, context-adaptive variable length coding (CAVLC), context-adaptive binary arithmetic coding (CABAC), and the like. The entropy encoder 240 may encode information necessary for video/image reconstruction other than quantized transform coefficients (ex. values of syntax elements, etc.) together or separately. Encoded information (ex. encoded video/image information) may be transmitted or stored in units of NALs (network abstraction layer) in the form of a bitstream. The video/image information may further include information on various parameter sets such as an adaptation parameter set (APS), a picture parameter set (PPS), a sequence parameter set (SPS), or a video parameter set (VPS). In addition, the video/image information may further include general constraint information. In the present disclosure, information and/or syntax elements transmitted/signaled from the encoding apparatus to the decoding apparatus may be included in video/picture information. The video/image information may be encoded through the above-described encoding procedure and included in the bitstream. The bitstream may be transmitted over a network or may be stored in a digital storage medium. The network may include a broadcasting network and/or a communication network, and the digital storage medium may include various storage media such as USB, SD, CD, DVD, Blu-ray, HDD, SSD, and the like. A transmitter (not shown) transmitting a signal output from the entropy encoder 240 and/or a storage unit (not shown) storing the signal may be included as internal/external element of the encoding apparatus 200, and alternatively, the transmitter may be included in the entropy encoder 240.

The quantized transform coefficients output from the quantizer 233 may be used to generate a prediction signal. For example, the residual signal (residual block or residual samples) may be reconstructed by applying dequantization and inverse transform to the quantized transform coefficients through the dequantizer 234 and the inverse transformer 235. The adder 250 adds the reconstructed residual signal to the prediction signal output from the inter predictor 221 or the intra predictor 222 to generate a reconstructed signal (reconstructed picture, reconstructed block, reconstructed sample array). If there is no residual for the block to be processed, such as a case where the skip mode is applied, the predicted block may be used as the reconstructed block. The adder 250 may be called a reconstructor or a reconstructed block generator. The generated reconstructed signal may be used for intra prediction of a next block to be processed in the current picture and may be used for inter prediction of a next picture through filtering as described below.

Meanwhile, luma mapping with chroma scaling (LMCS) may be applied during picture encoding and/or reconstruction.

The filter 260 may improve subjective/objective image quality by applying filtering to the reconstructed signal. For example, the filter 260 may generate a modified reconstructed picture by applying various filtering methods to the reconstructed picture and store the modified reconstructed picture in the memory 270, specifically, a DPB of the memory 270. The various filtering methods may include, for example, deblocking filtering, a sample adaptive offset, an adaptive loop filter, a bilateral filter, and the like. The filter 260 may generate various information related to the filtering and transmit the generated information to the entropy encoder 240 as described later in the description of each filtering method. The information related to the filtering may be encoded by the entropy encoder 240 and output in the form of a bitstream.

The modified reconstructed picture transmitted to the memory 270 may be used as the reference picture in the inter predictor 221. When the inter prediction is applied through the encoding apparatus, prediction mismatch between the encoding apparatus 200 and the decoding apparatus 300 may be avoided and encoding efficiency may be improved.

The DPB of the memory 270 may store the modified reconstructed picture for use as a reference picture in the inter predictor 221. The memory 270 may store the motion information of the block from which the motion information in the current picture is derived (or encoded) and/or the motion information of the blocks in the picture that have already been reconstructed. The stored motion information may be transmitted to the inter predictor 221 and used as the motion information of the spatial neighboring block or the motion information of the temporal neighboring block. The memory 270 may store reconstructed samples of reconstructed blocks in the current picture and may transfer the reconstructed samples to the intra predictor 222.

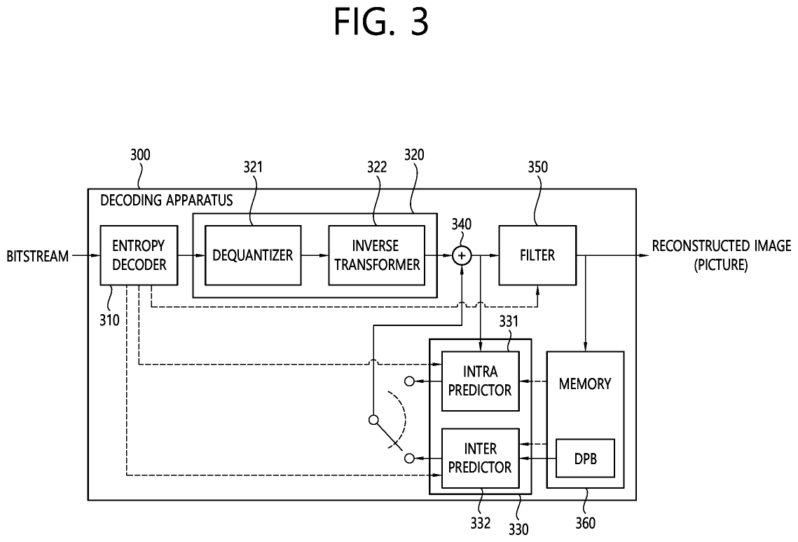

FIG. 3 is a schematic diagram illustrating a configuration of a video/image decoding apparatus to which the embodiment(s) of the present disclosure may be applied.

Referring to FIG. 3, the decoding apparatus 300 may include an entropy decoder 310, a residual processor 320, a predictor 330, an adder 340, a filter 350, a memory 360. The predictor 330 may include an intra predictor 331 and an inter predictor 332. The residual processor 320 may include a dequantizer 321 and an inverse transformer 322. The entropy decoder 310, the residual processor 320, the predictor 330, the adder 340, and the filter 350 may be configured by a hardware component (ex. A decoder chipset or a processor) according to an embodiment. In addition, the memory 360 may include a decoded picture buffer (DPB) or may be configured by a digital storage medium. The hardware component may further include the memory 360 as an internal/external component.

When a bitstream including video/image information is input, the decoding apparatus 300 may reconstruct an image corresponding to a process in which the video/image information is processed in the encoding apparatus of FIG. 2. For example, the decoding apparatus 300 may derive units/blocks based on block partition related information obtained from the bitstream. The decoding apparatus 300 may perform decoding using a processor applied in the encoding apparatus. Thus, the processor of decoding may be a coding unit, for example, and the coding unit may be partitioned according to a quad tree structure, binary tree structure and/or ternary tree structure from the coding tree unit or the largest coding unit. One or more transform units may be derived from the coding unit. The reconstructed image signal decoded and output through the decoding apparatus 300 may be reproduced through a reproducing apparatus.

The decoding apparatus 300 may receive a signal output from the encoding apparatus of FIG. 2 in the form of a bitstream, and the received signal may be decoded through the entropy decoder 310. For example, the entropy decoder 310 may parse the bitstream to derive information (ex. video/image information) necessary for image reconstruction (or picture reconstruction). The video/image information may further include information on various parameter sets such as an adaptation parameter set (APS), a picture parameter set (PPS), a sequence parameter set (SPS), or a video parameter set (VPS). In addition, the video/image information may further include general constraint information. The decoding apparatus may further decode picture based on the information on the parameter set and/or the general constraint information. Signaled/received information and/or syntax elements described later in the present disclosure may be decoded may decode the decoding procedure and obtained from the bitstream. For example, the entropy decoder 310 decodes the information in the bitstream based on a coding method such as exponential Golomb coding, CAVLC, or CABAC, and output syntax elements required for image reconstruction and quantized values of transform coefficients for residual. More specifically, the CABAC entropy decoding method may receive a bin corresponding to each syntax element in the bitstream, determine a context model using a decoding target syntax element information, decoding information of a decoding target block or information of a symbol/bin decoded in a previous stage, and perform an arithmetic decoding on the bin by predicting a probability of occurrence of a bin according to the determined context model, and generate a symbol corresponding to the value of each syntax element. In this case, the CABAC entropy decoding method may update the context model by using the information of the decoded symbol/bin for a context model of a next symbol/bin after determining the context model. The information related to the prediction among the information decoded by the entropy decoder 310 may be provided to the predictor (the inter predictor 332 and the intra predictor 331), and the residual value on which the entropy decoding was performed in the entropy decoder 310, that is, the quantized transform coefficients and related parameter information, may be input to the residual processor 320. The residual processor 320 may derive the residual signal (the residual block, the residual samples, the residual sample array). In addition, information on filtering among information decoded by the entropy decoder 310 may be provided to the filter 350. Meanwhile, a receiver (not shown) for receiving a signal output from the encoding apparatus may be further configured as an internal/external element of the decoding apparatus 300, or the receiver may be a component of the entropy decoder 310. Meanwhile, the decoding apparatus according to the present disclosure may be referred to as a video/image/picture decoding apparatus, and the decoding apparatus may be classified into an information decoder (video/image/picture information decoder) and a sample decoder (video/image/picture sample decoder). The information decoder may include the entropy decoder 310, and the sample decoder may include at least one of the dequantizer 321, the inverse transformer 322, the adder 340, the filter 350, the memory 360, the inter predictor 332, and the intra predictor 331.

The dequantizer 321 may dequantize the quantized transform coefficients and output the transform coefficients. The dequantizer 321 may rearrange the quantized transform coefficients in the form of a two-dimensional block form. In this case, the rearrangement may be performed based on the coefficient scanning order performed in the encoding apparatus.

The dequantizer 321 may perform dequantization on the quantized transform coefficients by using a quantization parameter (ex. quantization step size information) and obtain transform coefficients.

The inverse transformer 322 inversely transforms the transform coefficients to obtain a residual signal (residual block, residual sample array).

The predictor may perform prediction on the current block and generate a predicted block including prediction samples for the current block. The predictor may determine whether intra prediction or inter prediction is applied to the current block based on the information on the prediction output from the entropy decoder 310 and may determine a specific intra/inter prediction mode.

The predictor 320 may generate a prediction signal based on various prediction methods described below. For example, the predictor may not only apply intra prediction or inter prediction to predict one block but also simultaneously apply intra prediction and inter prediction. This may be called combined inter and intra prediction (CIIP). In addition, the predictor may be based on an intra block copy (IBC) prediction mode or a palette mode for prediction of a block. The IBC prediction mode or palette mode may be used for content image/video coding of a game or the like, for example, screen content coding (SCC). The IBC basically performs prediction in the current picture but may be performed similarly to inter prediction in that a reference block is derived in the current picture. That is, the IBC may use at least one of the inter prediction techniques described in the present disclosure. The palette mode may be considered as an example of intra coding or intra prediction. When the palette mode is applied, a sample value within a picture may be signaled based on information on the palette table and the palette index.

The intra predictor 331 may predict the current block by referring to the samples in the current picture. The referred samples may be located in the neighborhood of the current block or may be located apart according to the prediction mode. In the intra prediction, prediction modes may include a plurality of non-directional modes and a plurality of directional modes. The intra predictor 331 may determine the prediction mode applied to the current block by using a prediction mode applied to a neighboring block.

The inter predictor 332 may derive a predicted block for the current block based on a reference block (reference sample array) specified by a motion vector on a reference picture. In this case, in order to reduce the amount of motion information transmitted in the inter prediction mode, motion information may be predicted in units of blocks, sub-blocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. For example, the inter predictor 332 may configure a motion information candidate list based on neighboring blocks and derive a motion vector of the current block and/or a reference picture index based on the received candidate selection information. Inter prediction may be performed based on various prediction modes, and the information on the prediction may include information indicating a mode of inter prediction for the current block.

The adder 340 may generate a reconstructed signal (reconstructed picture, reconstructed block, reconstructed sample array) by adding the obtained residual signal to the prediction signal (predicted block, predicted sample array) output from the predictor (including the inter predictor 332 and/or the intra predictor 331). If there is no residual for the block to be processed, such as when the skip mode is applied, the predicted block may be used as the reconstructed block.

The adder 340 may be called reconstructor or a reconstructed block generator. The generated reconstructed signal may be used for intra prediction of a next block to be processed in the current picture, may be output through filtering as described below, or may be used for inter prediction of a next picture.

Meanwhile, luma mapping with chroma scaling (LMCS) may be applied in the picture decoding process.

The filter 350 may improve subjective/objective image quality by applying filtering to the reconstructed signal. For example, the filter 350 may generate a modified reconstructed picture by applying various filtering methods to the reconstructed picture and store the modified reconstructed picture in the memory 360, specifically, a DPB of the memory 360.

The various filtering methods may include, for example, deblocking filtering, a sample adaptive offset, an adaptive loop filter, a bilateral filter, and the like.

The (modified) reconstructed picture stored in the DPB of the memory 360 may be used as a reference picture in the inter predictor 332. The memory 360 may store the motion information of the block from which the motion information in the current picture is derived (or decoded) and/or the motion information of the blocks in the picture that have already been reconstructed. The stored motion information may be transmitted to the inter predictor 260 so as to be utilized as the motion information of the spatial neighboring block or the motion information of the temporal neighboring block. The memory 360 may store reconstructed samples of reconstructed blocks in the current picture and transfer the reconstructed samples to the intra predictor 331.

In the present disclosure, the embodiments described in the filter 260, the inter predictor 221, and the intra predictor 222 of the encoding apparatus 200 may be the same as or respectively applied to correspond to the filter 350, the inter predictor 332, and the intra predictor 331of the decoding apparatus 300. The same may also apply to the unit 332 and the intra predictor 331.

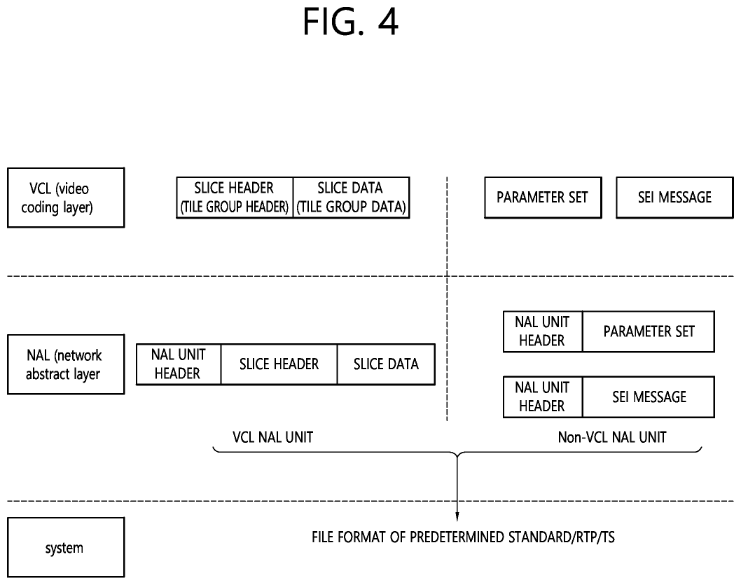

FIG. 4 exemplarily illustrates a layer structure for a coded video/image.

Referring to FIG. 4, a coded video/image may be divided into a video coding layer (VCL) that performs decoding processing of a video/image and handles the decoding processing, a lower system that transmits and stores coded information, and a network abstraction layer (NAL) which exists between the VCL and the lower system, and serves to perform a network adaptation function.

For example, VCL data including compressed image data (slice data), or a picture parameter set (PPS), a sequence parameter set (SPS), or a video parameter set (VPS), or a parameter set including a supplemental enhancement information (SEI) message additionally required in an image decoding process may be generated, in the VCL.

For example, in the NAL, header information (NAL unit data) is added to a raw byte sequence payload (RSRP) generated in the VCL to generate the NAL unit. In this case, the slice data, the parameter set, the SEI message, etc., generated in the VCL may be referred to, for the RBSP. The NAL unit header may include NAL unit type information specified according to RSRP data included in the corresponding NAL unit.

For example, as illustrated in FIG. 4, the NAL unit may be classified into a VCL NAL unit and a non-VCL NAL unit according to the RSRP generated in the VCL. The VCL NAL unit may mean a NAL unit including information (slice data) on the information, and the non-VCL NAL unit may mean a NAL unit including information (parameter set or SEI message) required to decode the image.

The VCL NA unit and the non-VCL NAL unit may be transmitted through a network while header information is added according to a data standard of a sub system. For example, the NAL unit may be converted into a data format of a predetermined standard such as an H.266/VVC file format, a real-time transport protocol (RTP), a transport stream (TS), etc., and transported through various networks.

Further, as described above, in respect to the NAL unit, an NAL unit type may be specified according to an RBSP data structure included in the corresponding NAL unit, and information on the NAL unit type may be stored in an NAL unit header and signaled.

For example, the NAL unit may be classified into a VCL NAL unit type and a non-VCL NAL unit type according to whether the NAL unit includes information (slice data) on the image. Further, the VCL NAL unit type may be classified according to a property and a type of picture included in the VCL NAL unit and the non-VCL NAL unit may be classified according to the type of parameter set.

The following is an example of the NAL unit type specified according to the type of parameter set included in the non-VCL NAL unit type.

Adaptation Parameter Set (APS) NAL unit: Type for the NAL unit including the APS

Decoding Parameter Set (DPS) NAL unit: Type for the NAL unit including the DPS

Video Parameter Set (VPS) NAL unit: Type for the NAL unit including the VPS

Sequence Parameter Set (SPS) NAL unit: Type for the NAL unit including the SPS

Picture Parameter Set (PPS) NAL unit: Type for the NAL unit including the PPS

Picture header (PH) NAL unit: Type for the NAL unit including the PH

The above-described NAL unit types may have syntax information for the NAL unit type and the syntax information may be stored in the NAL unit header and signaled. For example, the syntax information may be nal_unit_type and the NAL unit type may be specified as a value of nal_unit_type.

Meanwhile, one picture may include a plurality of slices, and the slice may include a slice header and slice data. In this case, one picture header may be added for the plurality of slices (a set of the slice header and the slice data). The picture header (picture header syntax) may include information/parameters which may be commonly applied to a picture. The slice header (slice header syntax) may include information/parameters which may be commonly applied to a slice. APS (ASP syntax) or PPS (PPS syntax) may include information/parameters which may be commonly applied to one or more slices or pictures. SPS (SPS syntax) may include information/parameters which may be commonly applied to one or more sequences. VPS (VPS syntax) may include information/parameters which may be commonly applied to a plurality of layers. DPS (DPS syntax) may include information/parameters which may be commonly applied to an overall image. The DPS may include information/parameter related to concatenation of a coded video sequence (CVS).

In the present disclosure, the image/video information encoded from the encoding apparatus to the decoding apparatus and signaled in the form of the bitstream may include intra-picture partitioning related information, intra/inter prediction information, interlayer prediction related information, residual information, and in-loop filtering information, and may include information included in the APS, information included in the PPS, information included in the SPS, information included in the VPS, and/or information included in the DPS. Further, the image/video information may further include information of the NAL unit header.

Meanwhile, the above-described encoded image/video information may be configured based on a media file format in order to generate the media file. For example, the encoded image/video information may form a media file (segment) based on one or more NAL units/sample entries for the encoded image/video information. The media file may include a sample entry and a track. For example, the media file (segment) may include various records, and each record information related to an image/video or information related to the media file format. Further, for example, one or more NAL units may be stored in a configuration record (or decoder configuration record, or VVC decoder configuration record) field of the media file. Here, the field may also be called a syntax element.

For example, as a media file format to which the method/embodiment disclosed in the present disclosure may be applied, ISO Base Media File Format (ISOBMFF) may be used. The ISOBMFF may be used based on a lot of codec encapsulation formats such as an AVC file format, an HEVC file format, and/or a VVC file format and a lot of multimedia container formats such as an MPEG-4 file format, a 3GPP file format (3GP), and/or a DVB file format. Further, static media and metadata such as the image may be stored in a file according to the ISOBMFF in addition to continuous media such as audio and video. A file structuralized according to the ISOBMFF may be used for various purposes including local media file playback, progressive downloading of a remote file, segments for dynamic adaptive streaming over HTTP (DASH), containers and packetization instructions of contents to be streamed, recording of received real-time media streams, etc.

A ‘box’ to be described below may be an elementary syntax element of the ISOBMFF. An ISOBMFF file may be constituted by a sequence of boxes, and another box may be included in the box. For example, a movie box (a box in which a grouping type is ‘moov’) may include metadata for continuous media streams including the media file, and each stream may be displayed as the track in the file. The metadata may be included in a track box (a box in which the grouping type is ‘trak’), and a media content of the track may be included in a media data box (a box in which the grouping type is ‘mdat’) or directly included in a separate file. The media content of the track may be constituted by a sequence of samples such as audio or video access units. For example, the ISOBMFF may specify tracks of types such as a media track including an elementary media stream, a hint track including media transmission instructions or representing a received packet stream, and a timed metadata track including time synchronized metadata.

Further, the ISOBMFF is designed for a storage usage, but is very useful even for streaming such as progressive download or DASH, for example. Movie fragments defined in the ISOMBFF may be used for a streaming usage. A fragmented ISOBMFF file may be represented by two tracks related to the video and the audio, for example. For example, when a random access is included after receiving the ‘moov’ box, all movie fragments ‘moof’ may be decoded together with related media data.

Further, the metadata of each track may include a coding or encapsulation format used for the track and a list of sample description entries providing initialization data required for processing the corresponding format. Further, each sample may be concatenated to one of the sample description entries of the track.

When the ISOBMFF is used, sample-specific metadata may be specified by various mechanisms. Specific boxes in a sample table box (a box in which the grouping type is ‘stb1’) may be standardized to cope with general requirements. For example, a sync sample box (a box in which the grouping type is ‘stss’) may be used for listing random access samples. When a sample grouping mechanism is used, samples may be mapped according to a four-character grouping type by a sample group sharing the same property specified as a sample group description entry. Various grouping types may be specified in the ISOBMFF.

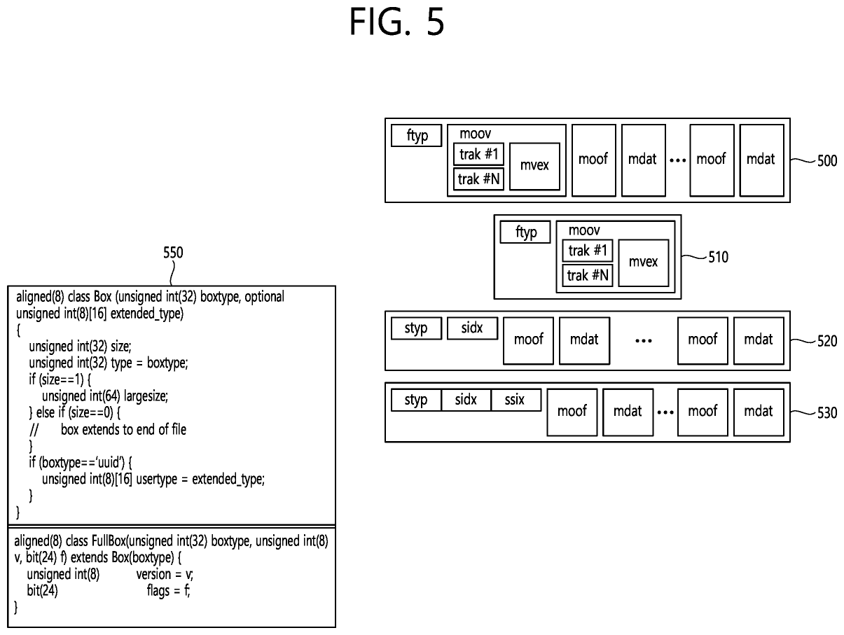

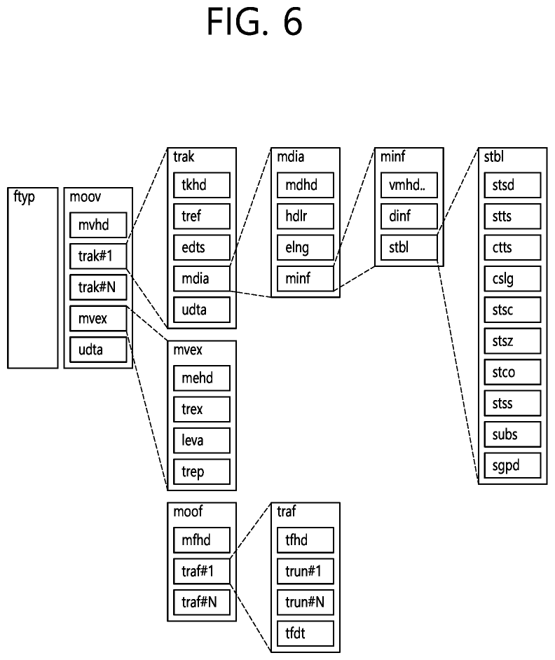

FIGS. 5 and 6 illustrate an example of a media file structure.

A media file may include at least one box. Here, a box may be a data block or an object including media data or metadata related to media data. Boxes may be in a hierarchical structure and thus data can be classified and media files can have a format suitable for storage and/or transmission of large-capacity media data. Further, media files may have a structure which allows users to easily access media information such as moving to a specific point of media content.

The media file may include an ftyp box, a moov box and/or an mdat box.

The ftyp box (file type box) can provide file type or compatibility related information about the corresponding media file. The ftyp box may include configuration version information about media data of the corresponding media file. A decoder can identify the corresponding media file with reference to ftyp box.

The moov box (movie box) may be a box including metadata about media data of the corresponding media file. The moov box may serve as a container for all metadata. The moov box may be a highest layer among boxes related to metadata. According to an embodiment, only one moov box may be present in a media file.

The mdat box (media data box) may be a box containing actual media data of the corresponding media file. Media data may include audio samples and/or video samples. The mdat box may serve as a container containing such media samples.

According to an embodiment, the aforementioned moov box may further include an mvhd box, a trak box and/or an mvex box as lower boxes.

The mvhd box (movie header box) may include information related to media presentation of media data included in the corresponding media file. That is, the mvhd box may include information such as a media generation time, change time, time standard and period of corresponding media presentation.

The trak box (track box) can provide information about a track of corresponding media data. The trak box can include information such as stream related information, presentation related information and access related information about an audio track or a video track. A plurality of trak boxes may be present depending on the number of tracks.

The trak box may further include a tkhd box (track head box) as a lower box. The tkhd box can include information about the track indicated by the trak box. The tkhd box can include information such as a generation time, a change time and a track identifier of the corresponding track.

The mvex box (movie extend box) can indicate that the corresponding media file may have a moof box which will be described later. To recognize all media samples of a specific track, moof boxes may need to be scanned.

According to an embodiment, the media file may be divided into a plurality of fragments (500). Accordingly, the media file can be fragmented and stored or transmitted. Media data (mdat box) of the media file can be divided into a plurality of fragments and each fragment can include a moof box and a divided mdat box. According to an embodiment, information of the ftyp box and/or the moov box may be required to use the fragments.

The moof box (movie fragment box) can provide metadata about media data of the corresponding fragment. The moof box may be a highest-layer box among boxes related to metadata of the corresponding fragment.

The mdat box (media data box) can include actual media data as described above. The mdat box can include media samples of media data corresponding to each fragment corresponding thereto.

According to an embodiment, the aforementioned moof box may further include an mfhd box and/or a traf box as lower boxes.

The mfhd box (movie fragment header box) can include information about correlation between divided fragments. The mfhd box can indicate the order of divided media data of the corresponding fragment by including a sequence number. Further, it is possible to check whether there is missed data among divided data using the mfhd box.

The traf box (track fragment box) can include information about the corresponding track fragment. The traf box can provide metadata about a divided track fragment included in the corresponding fragment. The traf box can provide metadata such that media samples in the corresponding track fragment can be decoded/reproduced. A plurality of traf boxes may be present depending on the number of track fragments.

According to an embodiment, the aforementioned traf box may further include a tfhd box and/or a trun box as lower boxes.

The tfhd box (track fragment header box) can include header information of the corresponding track fragment. The tfhd box can provide information such as a basic sample size, a period, an offset and an identifier for media samples of the track fragment indicated by the aforementioned traf box.

The trun box (track fragment run box) can include information related to the corresponding track fragment. The trun box can include information such as a period, a size and a reproduction time for each media sample.

The aforementioned media file and fragments thereof can be processed into segments and transmitted. Segments may include an initialization segment and/or a media segment.

A file of the illustrated embodiment (510) may include information related to media decoder initialization except media data. This file may correspond to the aforementioned initialization segment, for example. The initialization segment can include the aforementioned styp box and/or moov box.

A file of the illustrated embodiment (520) may include the aforementioned fragment. This file may correspond to the aforementioned media segment, for example. The media segment may further include an styp box and/or an sidx box.

The styp box (segment type box) can provide information for identifying media data of a divided fragment. The styp box can serve as the aforementioned ftyp box for a divided fragment. According to an embodiment, the styp box may have the same format as the ftyp box.

The sidx box (segment index box) can provide information indicating an index of a divided fragment. Accordingly, the order of the divided fragment can be indicated.

According to an embodiment (530), an ssix box may be further included. The ssix box (sub-segment index box) can provide information indicating an index of a sub-segment when a segment is divided into sub-segments.

Boxes in a media file can include more extended information based on a box or a FullBox as shown in the illustrated embodiment (550). In the present embodiment, a size field and a largesize field can represent the length of the corresponding box in bytes. A version field can indicate the version of the corresponding box format. A type field can indicate the type or identifier of the corresponding box. A flags field can indicate a flag associated with the corresponding box.

Meanwhile, fields (properties) for the video/image according to the present disclosure may be forwarded while being included in a DASH based adaptive streaming model.

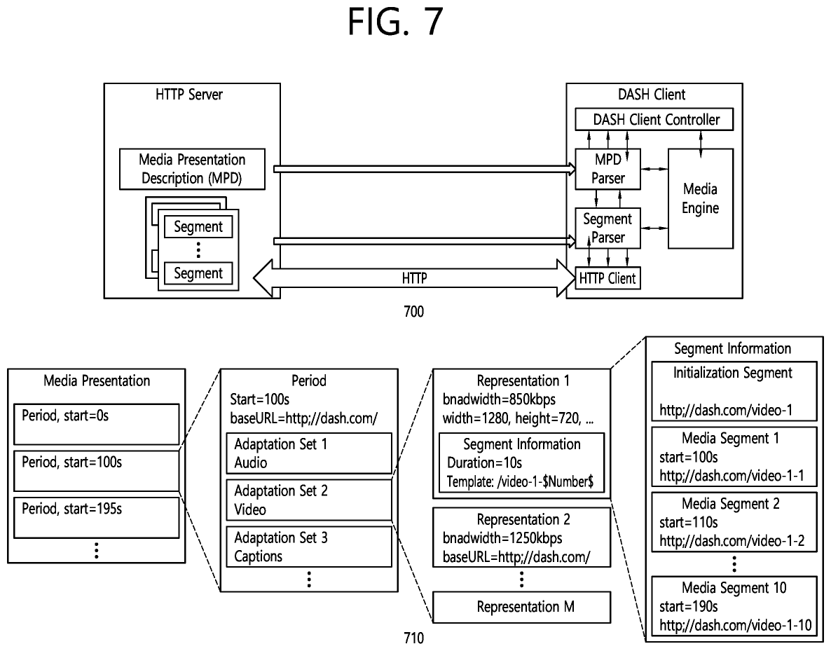

FIG. 7 illustrates an example of the overall operation of a DASH-based adaptive streaming model. The DASH-based adaptive streaming model according to an illustrated embodiment (700) illustrates an operation between an HTTP server and a DASH client. Here, Dynamic Adaptive Streaming over HTTP (DASH) is a protocol for supporting HTTP-based adaptive streaming and can dynamically support streaming according to a network state. Accordingly, AV content may be seamlessly reproduced.

First, the DASH client may acquire an MPD. The MPD may be delivered from a service provider, such as the HTTP server. The DASH client may request a segment from the server using segment access information described in the MPD. Here, this request may be performed in view of the network condition.

After acquiring the segment, the DASH client may process the segment in a media engine and may display the segment on a screen. The DASH client may request and acquire a necessary segment in view of reproduction time and/or the network state in real time (adaptive streaming) Accordingly, content may be seamlessly reproduced.

The media presentation description (MPD) is a file including detailed information for allowing the DASH client to dynamically acquire a segment and may be expressed in XML format.

A DASH client controller may generate a command to request an MPD and/or a segment in view of the network state. In addition, the controller may control acquired information to be used in an internal block, such as the media engine.

An MPD parser may parse the acquired MPD in real time. Accordingly, the DASH client controller can generate a command to acquire a required segment.

A segment parser may parse the acquired segment in real time. Depending on pieces of information included in the segment, internal blocks including the media engine may perform certain operations.

An HTTP client may request a required MPD and/or segment from the HTTP server. The HTTP client may also deliver an MPD and/or segment acquired from the server to the MPD parser or the segment parser.

The media engine may display content on a screen using media data included in the segment. Here, pieces of information of the MPD may be used.

A DASH data model may have a hierarchical structure (710). A media presentation may be described by the MPD. The MPD may describe a temporal sequence of a plurality of periods forming a media presentation. A period may represent one section of media content.

In one section, pieces of data may be included in adaptation sets. An adaptation set may be a collection of a plurality of media content components that can be exchanged with each other. An adaptation set may include a collection of representations. A representation may correspond to a media content component. Within one representation, content may be temporally divided into a plurality of segments, which may be for proper accessibility and delivery. The URL of each segment may be provided to enable access to each segment.

The MPD may provide information related to the media presentation, and a period element, an adaptation set element, and a presentation element may describe a period, an adaptation set, and a presentation, respectively. A representation may be divided into sub-representations, and a sub-representation element may describe a sub-representation.

Common properties/elements may be defined, which may be applied to (included in) an adaptation set, a representations, a sub-representation, or the like. Among the common properties/elements, there may be an essential property and/or a supplemental property.

The essential property may be information including elements that are considered essential in processing media presentation-related data. The supplemental property may be information including elements that may be used for processing the media presentation-related data. Descriptors to be described in the following embodiments may be defined and delivered in an essential property and/or a supplemental property when delivered via the MPD.

Meanwhile, a ‘sample’ to be described below may be all data related to a single time or a single element of one of three sample arrays (Y, Cb, and Cr) representing the picture. For example, when the terminology ‘sample’ is used in a context of the track (of the media file format), the ‘sample’ may mean all data related to the single time of the corresponding track. Here, the time may be a decoding time or a composition time. Further, for example, when the terminology ‘sample’ is used in the context of the picture, that is, when the ‘sample’ is used as a terminology of the picture like luma sample', the ‘sample’ may represent the single element in one of three sample arrays representing the picture.

Meanwhile, in order to store a VVC content, three types of elementary streams may be defined as follows.

A video elementary stream including VCL NAL units and not including any parameter sets, DCI, or OPI NAL unit; all parameter sets, DCI, and OPI NAL unit may be stored in one or more sample entries. In this case, the elementary video stream may be included in a non-VCL NAL unit which is not the parameter set, not the DCI NAL unit, and not the OPI NAL unit.

A video and parameter set elementary stream which may include the VCL NAL unit and include the parameter set, the DCI, or the OPI NAL unit, and have parameter sets, DCI, or OPI NAL unit stored in one or more sample entries.

A non-VCL elementary stream including only the non-VCL NAL unit. In this case, the non-VCL NAL unit is synchronized with the elementary stream included in the video track. In this case, the VVC non-VCL track does not include the parameter set, the DCI, or the OPI NAL unit in the sample entry.

Meanwhile, a sample entry ‘vvc1’ or ‘vvi1’ is essential in at least one track of the tracks forwarding a VVC bitstream. For a VVC sample entry, a sample entry type is defined as the same sample entry as ‘vvc1 ’ or ‘vvi1’. Further, each sample entry of a VVC track. Further, the VVC sample entry includes a VVC Configuration Box as defined below.

For example, optional BitRateBox may exist in the VVC sample entry in order to signal bit rate information of the VVC video stream. When being used, extension descriptors which should be inserted into an elementary stream descriptor may also exist.

For example, as being allowed in an ISO base media file format specification, multiple sample entries may be used for displaying a section of a video using other configurations or parameter sets.

When a VVC subpicture track includes a conforming VVC bitstream which may be consumed without other VVC subpicture tracks, a regular VVC sample entry (‘vvc1’ or ‘vvi1’) may be used for the VVC subpicture track.

Otherwise, when a sample entry ‘vvs1’ may be used for the VVC subpicture track, and the following restriction may be applied to the track.

A flag track_in_movie should be equal to 0.

The track should include only one sample entry.

The track should be referred to by at least one VVC base track through a track reference ‘subp’.

Decoding Capability Information (DCI), Operating Point Information (OPI), Video Parameter Set (VPS), Sequence Parameter Set (SPS), Picture Parameter Set (PPS), Access Unit

Delimiter (AUD), Picture Header (PH), End of Sequence (EOS), End of Bitstream (EOB), and other Access Unit-level (AU-level) or Picture-level non-video coding layer (non-VCL) network abstraction layer (NAL) units should exist in both the sample entry and the samples of the track ‘vvs1’.

Unless particularly specified, child boxes (e.g., CleanApertureBox and

PixelAspectRatioBox) of the video sample entry should not exist in the sample entry, and when the child boxes exist, the child boxes should be ignored.

Unless all VCL NAL units included in the sample do not observe sync sample requirements, the sample is not displayed as a sync sample.

Composition time offset information for the sample of the track ‘vvs1’ does not exist.

Subsample information for the sample of the track ‘vvs1’ may exist. When the subsample information exists, the subsample information should follow a definition of sub-samples for the VVC.

Meanwhile, the VVC track may include the track reference ‘subp’ together with an entry including one of a track_ID value of the VVC subpicture track or a track_group_jd of a track group ‘alte’ of the VVC subpicture track.

A sample group of a type ‘spor’ should exist in each VVC base track.

[Ed. (MH): A dedicated sample entry type for a VVC base track may represent the VVC base track through a codec MME parameter of the track type. On the contrary, it may not be preferable to specify a large number of VVC sample entry types.

Meanwhile, the sample entry of the type ‘vvs1’ may include VvcNALUConfigBox.

For example, when the VVC subpicture track is referred to by a VVC base track including a sample group description entry ‘spor’ in which subpic_id_info_flag is 1, the VVC subpicture track includes a subpicture ID sample group description potentially using a default sample grouping mechanism.

For example, when a sample entry name is ‘vvc1’ or ‘vvi1’, a stream to which the corresponding sample entry is applied should be a compliant VVC stream in terms of a VVD decoder operating under a configuration (including a profile, a tier, and a level) provided under VVCConfigurationBox.

For example, when the sample entry name is ‘vvc1’, a value of array_completeness should be equal to 1 for an array of DCI, VPS, SPS, and PPS NAL units and 1 for all other arrays. When the sample entry name is ‘vvi1’, the value of array_completeness should be equal to 0 for all arrays.

For example, when the track does not natively include the VVC bitstream and does not represent the VVC bitstream after resolving the track references ‘subp’ and ‘vvcN’ (when exist), the track should include an ‘oref’ type track reference for a track forwarding a sample group ‘vopi’ or for an operating point entity group.

Meanwhile, for example, when a single-layer VVC bitstream includes two temporal sublayers stored in different tracks, the track including a sublayer in which Temporalld is equal to 1 includes an ‘oref’ track reference for a track including a sublayer in which Temporalld is equal to 0.

Meanwhile, operating points may be a temporal subset of the OSL which may be identified by an output layer set (OLS) index and a highest value of Temporalld. Each operating point may be related to a profile, a tier, and a level (i.e., PTL) defining a conformance point of the operating point.

For example, operating points information of the ISO based media file format (ISOBMF) for the VVC may be signaled in a sample for a group box in which the grouping type is ‘vopi’ or signaled in an entity group of an ‘opeg’ type. The information is required for the sample entry for the sample and each operating point.

Meanwhile, in applications, different operating points provided the VVC bitstream given by using the operating point information sample group ('vopi') and a configuration thereof may be known. For example, each operating point is related to OLS, maximum TemporalInd value, profile, tier, and level signaling. All information described above may be captured by the sample group ‘vopi’. Apart from the above-described information, the sample group may also provide dependency information between layers.

For example, when one or more VVC tracks exist for the VVC bitstream and the operating point entity group does not exist for the VVC bitstream, two following matters may be all applied.

There should be only one track that forwards the sample group ‘vopi’ among the VVC tracks for the VVC bitstream.

All other VVC tracks for the VVC bitstream should have an ‘oref’ type track reference for the track that forwards the sample group ‘vopi’.

For example, with respect to any specific sample of a given track, a temporally collocated sample of another track may be defined as a sample having the same decoding time as a decoding time of the specific sample. The following is applied to each sample S_{N} of a track T_{N} having the ‘oref’ track reference for a track Tₖ that forwards the ‘vopi’ sample group.

When there is the temporally collocated sample Sₖ for the track Tₖ, the sample S_{N} may be related to the same ‘vopi’ sample group entity as the sample Sₖ.

Otherwise, the sample S_{N} may be related to the same ‘vopi’ sample group entity as a last sample of the track Tₖ preceding the sample S_{N} in the decoding time.

Meanwhile, when various VPSs are referred to by the VVC bitstream, the sample group description box in which the grouping type is ‘vopi’ may be required to include various entities. In a more general case in which there is single VPS, it may be recommended that the default sample group mechanism defined in IS O/IEC 14496-12 is used, and the operating points information sample group is included in not each track fragment but the sample table box.

For example, grouping_type_parameter may not be defined for SampleToGroupBox in which the grouping type is ‘vopi’

The syntax of the ‘vopi’ sample group including the operating point information, i.e., the operating point information sample group may be as in a table below.

```
TABLE 1
class VvcOperatingPointsRecord {
  unsigned int(8) num_profile_tier_level_minus1;
  for (i=0; i<=num_profile_tier_level_minus1; i++) {
    unsigned int(8) ptl_max_temporal_id[i];
    VvcPTLRecord(ptl_max_temporal_id[i]+1) ptl[i];
  }
  unsigned int(1) all_independent_layers_flag;
  bit(7) reserved = 0;
  if (all_independent_layers_flag) {
    unsigned int(1) each_layer_is_an_ols_flag;
    bit(7) reserved = 0;
  } else
    unsigned int(8) ols_mode_idc;
  bit(7) reserved = 0;
  unsigned int(9) num_olss;
  for (i=0; i<num_olss; i++) {
    unsigned int(8) ptl_idx[i];
    unsigned int(9) output_layer_set_idx[i];
    unsigned int(6) layer_count[i];
    bit(1) reserved = 0;
    for (j=0; j<layer_count; j++) {
      unsigned int(6) layer_id[i] [j];
      unsigned int(1) is_output_layer[i] [j];
      bit(1) reserved = 0;
    }
  }
  bit(4) reserved = 0;
  unsigned int(12) num_operating_points;
  for (i=0; i<num_operating_points; i++) {
    unsigned int(9) ols_idx;
    unsigned int(3) max_temporal_id;
    unsigned int(1) frame_rate_info_flag
    unsigned int(1) bit_rate_info_flag
    bit(5) reserved = 0;
    unsigned int(2) chroma_format_idc;
    unsigned int(3) bit_depth_minus8;
    unsigned_int(16) picture_width;
    unsigned_int(16) picture_height;
    if (frame_rate_info_flag) {
      unsigned int(16) avgFrameRate;
      bit(6) reserved = 0;
      unsigned int(2) constantFrameRate;
    }
    if (bit_rate_info_flag) {
      unsigned int(32) maxBitRate;
      unsigned int(32) avgBitRate;
    }
  }
  unsigned int(8) max_layer_count;
  for (i=0; i<max_layer_count; i++) {
    unsigned int(8) layerID;
    unsigned int(8) num_direct_ref_layers;
    for (j=0; j<num_direct_ref_layers; j++) {
      unsigned int(8) direct_ref_layerID;
      unsigned int(8) max_tid_il_ref_pics_plus1;
    }
  }
}
class VvcOperatingPointsInformation extends VisualSampleGroupEntry
(‘vopi’) {
  VvcOperatingPointsRecord oinf;
}
```

Further, semantics for the syntax of the operating point information sample group may be as in a table below.

```
TABLE 2
num_profile_tier_level_minus1 plus 1 gives the number of the subsequent profiles,
  tier, and level combinations as well as the associated fields.
ptl_max_temporal_id[i]: Gives the maximum TemporalID of NAL units of the
  associated bitstream for the specified i-th profile, tier, and level structure.
```

NOTE 1: The semantics of ptl_max_temporal_id[i] and max_temporal_id of an

```
    operating point, given below, are different even though they may carry the same numerical value.
ptl[i] specifies the i-th profile, tier, and level structure.
all_independent_layers_flag, each_layer_is_an_ols_flag,
  ols_mode_idc and max_tid_il_ref_pics_plus1 are defined in ISO/IEC 23090-3.
num_olss specifies the number of output layer sets signalled in this syntax structure. The value of
  num_olss shall be less than or equal to the value of TotalNumOlss as specified in ISO/IEC
  23090-3.
ptl_idx[i] specifies the zero-based index of the listed profile, tier, and level structure for the i-
  th output layer set signalled in this syntax structure.
output_layer_set_idx[i] is the output layer set index of the i-th output layer set signalled
  in this syntax structure.
layer_count[i] specifies the number of layers in the i-th output layer set signalled in this
  syntax structure.
layer_id[i] [j] specifies the nuh_layer_id value for the j-th layer in the i-th output layer set
  signalled in this syntax structure.
is_output_layer[i] [j] equal to 1 specifies that the j-th layer is an output layer in the i-th
  output layer set signalled in this syntax structure. is_output_layer[i][j] equal to 0 specifies that the
  j-th layer in not an output layer in the i-th output layer set signalled in this syntax structure.
num_operating_points: Gives the number of operating points for which the
  information follows.
ols_idx is the index to the list of output layer sets signalled in this syntax structure for the
  operating point.
max_temporal_id indicates the maximum TemporalId of NAL units of this operating
  point.
frame_rate_info_flag equal to 0 indicates that no frame rate information is present
  for the operating point. The value 1 indicates that frame rate information is present for the
  operating point.
  bit_rate_info_flag equal to 0 indicates that no bitrate information is present for the
    operating point. The value 1 indicates that bitrate information is present for the operating
    point.
  chroma_format_idc indicates the chroma format that applies to this operating point. The
    following constraints apply for chroma_format_idc:
```

| | |
|---|---|
| - | If this operating point contains only one layer, the value of sps_chroma_format_idc, as |
| | defined in ISO/IEC 23090-3, shall be the same in all SPSs referenced by the VCL NAL units |
| | in the VVC bitstream of this operating point, and the value of chroma_format_idc |
| | shall be equal to that value of sps_chroma_format_idc. |
| - | Otherwise (this operating point contains more than one layer), the value of |
| | chroma_format_idc shall be equal to the value of |
| | vps_ols_dpb_chroma_format[ MultiLayerOlsIdx[ output_layer_set_id ] ], as |
| | defined in ISO/IEC 23090-3. |

bit_depth_minus8 indicates the bit depth that applies to this operating point. The following
constraints apply for bit_depth_minus8:

| | |
|---|---|
| - | If this operating point contains only one layer, the value of sps_bitdepth_minus8, as |
| | defined in ISO/IEC 23090-3, shall be the same in all SPSs referenced by the VCL NAL units |
| | in the VVC bitstream of this operating point, and the value of bit_depth_minus8 shall |
| | be equal to that value of sps_bitdepth_minus8. |
| - | Otherwise(this operating point contains more than one layer), the value of |
| | bit_depth_minus8 shall be equal to the value of |
| | vps_ols_dpb_bitdepth_minus8[ MultiLayerOlsIdx[ output_layer_set_ids ] ], as |
| | defined in ISO/IEC 23090-3. |

picture_width indicates the maximum picture width, in units of luma samples, that applies to
this operating point. The following constraints apply for picture_width:

| | |
|---|---|
| - | If this operating point contains only one layer, the value of |
| | sps_pic_width_max_in_luma_samples, as defined in ISO/IEC 23090-3, shall be the same |
| | in all SPSs referenced by the VCL NAL units in the VVC bitstream of this operating point, |
| | and the value of picture_width shall be equal to that value of |
| | sps_pic_width_max_in_luma_samples. |
| - | Otherwise (this operating point contains more than one layer), the value of |
| | picture_width shall be equal to the value of |
| | vps_ols_dpb_pic_width[ MultiLayerOlsIdx[ output_layer_set_idx ] ], as defined in |
| | ISO/IEC 23090-3. |

picture_height indicates the maximum picture height, in units of luma samples, that applies to
this operating point. The following constraints apply for picture_height:

| | |
|---|---|
| - | If this operating point contains only one layer, the value of |
| | sps_pic_height_max_in_luma_samples, as defined in ISO/IEC 23090-3, shall be the same |
| | in all SPSs referenced by the VCL NAL units in the VVC bitstream of this operating point, |
| | and the value of picture_height shall be equal to that value of |
| | sps_pic_height_max_in_luma_samples. |
| - | Otherwise (this operating point contains more than one layer), the value of |
| | picture_height shall be equal to the value of |
| | vps_ols_dpb_pic_height[ MultiLayerOlsIdx[ output_layer_set_idx ] ], as defined |
| | in ISO/IEC 23090-3. |

```
  avgFrameRate gives the average frame rate in units of frames/(256 seconds) for the
    operating point. Value 0 indicates an unspecified average frame rate. When the bitstream
    of the operating point contains multiple layers, this gives the average access unit rate.
  constantFrameRate equal to 1 indicates that the stream of the operating point is of
    constant frame rate. Value 2 indicates that the representation of each temporal layer in the
    stream of the operating point is of constant frame rate. Value 0 indicates that the stream of
    the operating point may or may not be of constant frame rate. When the bitstream of the
  operating point contains multiple layers, this gives the indication of whether the bitstream
  of the operating point has constant access unit rate.
maxBitRate gives the maximum bit rate in bits/second of the stream of the operating point,
  over any window of one second.
avgBitRate gives the average bit rate in bits/second of the stream of the operating point.
max_layer_count specifies the count of all unique layers in all of the operating points
  described in the sample group entry.
layerID specifies nuh_layer_id of a layer for which all the direct reference layers are given
  in the following loop of direct_ref_layerID.
num_direct_ref_layers specifies the number of direct reference layers for the layer
  with nuh_layer_id equal to layerID.
direct_ref_layerID indicates nuh_layer_id of the direct reference layer.
max_tid_il_ref_pics_plus1 equal to 0 specifies that the pictures of the layer with
  nuh_layer_id equal to direct_ref_layerID that are neither IRAP pictures nor GDR
  pictures with ph_recovery_poc_cnt equal to 0 are not used as inter-layer reference pictures
  for decoding of pictures of the layer with nuh_layer_id equal to layerID. A value greater
  than 0 specifies that, for decoding pictures of the layer with nuh_layer_id equal to
  layerID, no picture from the layer with nuh_layer_id equal to
  direct_ref_layerID with TemporalId greater than
  max_tid_il_ref_pics_plus1 − 1 is used as an inter-layer reference picture and no
  APS with nuh_layer_id equal to direct_ref_layerID and TemporalId greater than
  max_tid_il_ref_pics_plus1 − 1 is referenced.
```

Meanwhile, the operating point entity group may be defined to provide mapping of the track to the operating point and profile level information of the operating point.

For example, when the sample of the track mapped to the operating point described in the operating point entity group is aggregated, the VCL NAL unit need not be removed any longer in order to obtain a conforming VVC bitstream in an implicit reconstruction process. The track which belongs to the operating point entity group should have the track reference of the type ‘oref’ for group_id displayed in the operating point entity group, and should not forward the ‘vopi’ sample group.

For example, all entity_id values included in the operating point entity group should represent track IDs of the tracks which belong to the same VVC bitstream. When exists, OperatingPointGroupBox is included in GroupsListBox of file-level MetaBox and not included in MetaBox of other levels.

The syntax of the operating point entity group may be as in a table below.

TABLE 3

```
aligned(8) class OperatingPointGroupBox extends
EntityToGroupBox(‘opeq’,0,0)
{
  unsigned int(8) num_profile_tier_level_minus1;
  for (i=0; i<=num_profile_tier_level_minus1; i++)
    VvcPTLRecord(0) opeg_ptl[i];
  bit(7) reserved = 0;
  unsigned int(9) num_olss;
  for (i=0; i<num_olss; i++) {
    unsigned int(8) ptl_idx[i];
    unsigned int(9) output_layer_set_idx[i];
    unsigned int(6) layer_count[i];
    bit(1) reserved = 0;
    for (j=0; j<layer_count; j++) {
      unsigned int(6) layer_id[i] [j];
      unsigned int(1) is_output_layer[i] [j];
      bit(1) reserved = 0;
    }
  }
  bit(4) reserved = 0;
  unsigned int(12) num_operating_points;
  for (i=0; i<num_operating_points; i++) {
    unsigned int(9) ols_idx;
    unsigned int(3) max_temporal_id;
    unsigned int(1) frame_rate_info_flag
    unsigned int(1) bit_rate_info_flag
    bit(5) reserved = 0;
    unsigned int(2) chroma_format_idc;
    unsigned int(3) bit_depth_minus8;
    unsigned_int(16) picture_width;
    unsigned_int(16) picture_height;
    if (frame_rate_info_flag) {
      unsigned int(16) avgFrameRate;
      bit(6) reserved = 0;
      unsigned int(2) constantFrameRate;
    }
    if (bit_rate_info_flag) {
      unsigned int(32) maxBitRate;
      unsigned int(32) avgBitRate;
    }
    unsigned int(8) entity_count;
    for (j=0; j<entity_count; j++) {
      unsigned int(8) entity_idx;
    }
  }
}
```

Further, the semantics for the syntax of the operating point entity group may be as in a table below.

```
TABLE 4
num_profile_tier_level_minus1 plus 1 gives the number of following profiles, tier,
  and level combinations as well as the associated fields.
opeg_ptl[i] specifies the i-th profile, tier, and level structure.
num_olss specifies the number of output layer sets signalled in this syntax structure. The value of
  num_olss shall be less than or equal to the value of TotalNumOlss as specified in ISO/IEC
  23090-3.
ptl_idx[i] specifies the zero-based index of the listed profile, tier, and level structure for the i-
  th output layer set signalled in this syntax structure.
output_layer_set_idx[i] is the output layer set index of the i-th output layer set signalled
  in this syntax structure.
layer count [i] specifies the number of layers in the i-th output layer set signalled in this
  syntax structure.
layer_id[i] [j] specifies the nuh_layer_id value for the j-th layer in the i-th output layer set
  signalled in this syntax structure.
is_output_layer[i] [j] equal to 1 specifies that the j-th layer is an output layer in the i-th
  output layer set signalled in this syntax structure. is_output_layer[i][j] equal to 0 specifies that the
  j-th layer in not an output layer in the i-th output layer set signalled in this syntax structure.
num_operating_points: Gives the number of operating points for which the
  information follows.
ols_idx is the index to the list of output layer sets signalled in this syntax structure for the
  operating point.
max_temporal_id: Gives the maximum TemporalId of NAL units of this operating point.
frame_rate_info_flag equal to 0 indicates that no frame rate information is present
  for the operating point. The value 1 indicates that frame rate information is present for the
  operating point.
bit_rate_info_flag equal to 0 indicates that no bitrate information is present for
  the operating point. The value 1 indicates that bitrate information is present for the
  operating point.
chroma_format_idc indicates the chroma format that applies to this operating point. The
  following constraints apply for chroma_format_idc:
```

| | |
|---|---|
| - | If this operating point contains only one layer, the value of sps_chroma_format_idc, as |
| | defined in ISO/IEC 23090-3, shall be the same in all SPSs referenced by the VCL NAL units |
| | in the VVC bitstream of this operating point, and the value of chroma_format_idc. |
| | shall be equal to that value of sps_chroma_format_idc. |
| - | Otherwise (this operating point contains more than one layer), the value of |
| | chroma_format_idc shall be equal to the value of |
| | vps_ols_dpb_chroma_format[ MultiLayerOlsIdx[ output_layer_set_idx ] ], as |
| | defined in ISO/IEC 23090-3. |

bit_depth_minus8 indicates the bit depth that applies to this operating point The following
constraints apply for bit_depth_minus8:

| | |
|---|---|
| - | If this operating point contains only one layer, the value of sps_bitdepth_minus8, as |
| | defined in ISO/IEC 23090-3, shall be the same in all SPSs referenced by the VCL NAL units |
| | in the VVC bitstream of this operating point, and the value of bit_depth_minus8 shall |
| | be equal to that value of sps_bitdepth_minus8. |
| - | Otherwise(this operating point contains more than one layer), the value of |
| | bit_depth_minus8 shall be equal to the value of |
| | vps_ols_dpb_bitdepth_minus8[ MultiLayerOlsIdx[ output_layer_set_idx ] ], as |
| | defined in ISO/IEC 23090-3. |

picture_width indicates the maximum picture width, in units of luma samples, that applies to
this operating point. The following constraints apply for picture_width:

| | |
|---|---|
| - | If this operating point contains only one layer, the value of |
| | sps_pic_width_max_in_luma_samples, as defined in ISO/IEC 23090-3, shall be the same |
| | in all SPSs referenced by the VCL NAL units in the VVC bitstream of this operating point, |
| | and the value of picture_width shall be equal to that value of |
| | sps_pic_width_max_in_luma_samples. |
| - | Otherwise (this operating point contains more than one layer), the value of |
| | picture_width shall be equal to the value of |
| | vps_ols_dpb_pic_width[ MultiLayerOlsIdx[ output_layer_set_idx ] ], as defined in |
| | ISO/IEC 23090-3. |

picture_height indicates the maximum picture height, in units of luma samples, that applies to
this operating point. The following constraints apply for picture_height:

| | |
|---|---|
| - | If this operating point contains only one layer, the value of |
| | sps_pic_height_max_in_luma_samples, as defined in ISO/IEC 23090-3, shall be the same |
| | in all SPSs referenced by the VCL NAL units in the VVC bitstream of this operating point, |
| | and the value of picture_height shall be equal to that value of |
| | sps_pic_height_max_in_luma_samples. |
| - | Otherwise (this operating point contains more than one layer), the value of |
| | picture_height shall be equal to the value of |
| | vps_ols_dpb_pic_height[ MultiLayerOlsIdx[ output_layer_set_idx ] ], as defined |
| | in ISO/IEC 23090-3. |

```
avgFrameRate gives the average frame rate in units of frames/(256 seconds) for the
  operating point. Value 0 indicates an unspecified average frame rate.
constantFrameRate equal to 1 indicates that the stream of the operating point is of
  constant frame rate. Value 2 indicates that the representation of each temporal layer in the
  stream of the operating point is of constant frame rate. Value 0 indicates that the stream of
  the operating point may or may not be of constant frame rate.
maxBitRate gives the maximum bit rate in bits/second of the stream of the operating point,
  over any window of one second.
avgBitRate gives the average bit rate in bits/second of the stream of the operating point.
entity_count specifies the number of tracks that are present in an operating point.
entity_idx specifies the index to the entity_id list in the entity group that belongs to
  an operating point.
```

For example the media file may include decoder configuration information for an image/video content. That is, the media file may include a VVC decoder configuration record including decoder configuration information.

Meanwhile, when the VVC decoder configuration record is stored in the sample entry, the VVC decoder configuration record may include a size of a length field used in each sample in order to a length of the NAL unit included in addition to the parameter set, the DCI, the OPI, and the SEI NAL unit. The VVC decoder configuration record may be framed externally (a size of the VVC decoder configuration record is provided in a structure including the VVC decoder configuration record).

Further, the VVC decoder configuration record may include a version field. In respect to a version in the present disclosure, version 1 of the VVC decoder configuration record may be defined. Incompatible changes for the VVC decoder configuration record may be represented as a change of a version number. When the version number is not recognized, readers should not decode the VVC decoder configuration record or a stream to which the corresponding record is applied.

Further, for example, compatible extension for the VVC decoder configuration record extend the VVC decoder configuration record and may not change a configuration version code. The readers should be ready for ignore unrecognized data which exceeds a definition of data appreciated by the readers.

Meanwhile, when the track includes the VVC bitstream natively or by resolving the ‘subp’ track references, VvcPtlRecord should exist in the decoder configuration record, and in this case, a concrete output layer set is represented as a field output_layer_set_idx.

For example, when ptl_present_flag in the decoder configuration record of the track is equal to 0, the track should have the ‘oref’ track reference for a DI capable of referring to the VVC track or the ‘opeg’ entity group.

Meanwhile, when the stream described in the VVC decoder configuration record is decoded, values of syntax elements of VvcPTLRecord, chroma_format_jdc, and bit_depth_minus8 may be valid for all parameter sets. In particular, the following restrictions may be applied.

A profile indication general_profile_idc represents a profile to which the output layer set identified by output_layer_set_idx in the configuration record conforms.

For example, when other profiles are represented for other CVSs of the output layer set identified by output_layer_set_idx in the configuration record, the stream may be required to be examined in order to determine a profile (if it exists) to which an entire stream conforms. Further, for example, when the entire stream is not examined or it is revealed that there is no profile observed by the entire stream, it is anticipated that the entire stream is to be divided into two or more sub-streams having separate configuration records to which such a rule may be applied.

A tier indication general_tier_flag represents a tier which is equal to or larger than a highest tier represented in all profile_tier_level( )syntax structures (in all parameter sets) to which the output layer set identified by output_layer_set_idx in the configuration record conforms.

Each bit of general_constraint_info may be set only when the corresponding bit in all general_constraints_info( )syntax structures in all profile_tier_level( )syntax structures (in all parameter sets) to which the output layer set identified by output_layer_set_idx in the configuration record conforms is set.

A level indication general_tier_flag represents a tier which is equal to or larger than a highest tier represented in all profile_tier_level( )syntax structures (in all parameter sets) to which the output layer set identified by output_layer_set_idx in the configuration record conforms.

Further, the following constraints may be applied even to chroma_format_idc.

When the VVC stream to which the configuration record is applied is the single-layer bitstream, a value of sps_chroma_format_idc defined in ISO/IEC 23090-3 should be the same within all SPSs referred to by the VCL NAL unit in the sample to which a current sample entry description is applied, and a value of chroma_format_idc should be equal to the value of sps_chroma_format_idc.

Otherwise (when the VVC stream to which the configuration record is applied is a multi-layer bitstream), a value of vps_ols_dpb_chroma_format[MultiLayerOlsIdx[output_layer_set_idx]] defined in ISO/IEC 23090-3 should be the same for all CVSs to which the current sample entry description is applied, and the value of chroma_format_idc should be equal to a value of vps_ols_dpb_chroma_format[MultiLayerOlsIdx[output_layer_set_idx]].

Further, the following constraints may be applied even to bit_depth_minus8.

When the VVC stream to which the configuration record is applied is the single-layer bitstream, a value of sps_bitdepth_minus8 defined in ISO/IEC 23090-3 should be the same within all SPSs referred to by the VCL NAL unit in the sample to which the current sample entry description is applied, and a value of bit_depth_minus8 should be equal to the value of sps_bitdepth_minus8.

Otherwise (when the VVC stream to which the configuration record is applied is the multi-layer bitstream), a value of vps_ols_dpb_bitdepth_minus8[MultiLayerOlsIdx[output_layer_set_idx]] defined in ISO/IEC 23090-3 should be the same for all CVSs to which the current sample entry description is applied, and the value of bit_depth_minus8 should be equal to a value of vps_ols_dpb_bitdepth_minus8 [MultiLayerOlsIdx[output_layer_set_idx]].

Further, the following constraints may be applied even to picture_width.

When the VVC stream to which the configuration record is applied is the single-layer bitstream, a value of sps_pic_width_max_in_luma_samples defined in ISO/IEC 23090-3 should be the same within all SPSs referred to by the VCL NAL unit in the sample to which a current sample entry description is applied, and a value of picture_width should be equal to the value of sps_pic_width_max_in_luma_samples.

Otherwise (when the VVC stream to which the configuration record is applied is the multi-layer bitstream), a value of vps_ols_dpb_pic_width[MultiLayerOlsIdx[output_layer_set_idx]] defined in ISO/IEC 23090-3 should be the same for all CVSs to which the current sample entry description is applied, and the value of picture_width should be equal to a value of vps_ols_dpb_pic_width[MultiLayerOlsIdx[output_layer_set_idx]].

Further, the following constraints may be applied even to picture_height.

When the VVC stream to which the configuration record is applied is the single-layer bitstream, a value of sps_pic_height_max_in_luma_samples defined in ISO/IEC 23090-3 should be the same within all SPSs referred to by the VCL NAL unit in the sample to which a current sample entry description is applied, and a value of picture_height should be equal to the value of sps_pic_height_max_in_luma_samples.

Otherwise (when the VVC stream to which the configuration record is applied is the multi-layer bitstream), a value of vps_ols_dpb_pic_height[MultiLayerOlsIdx[output_layer_set_idx]] defined in ISO/IEC 23090-3 should be the same for all CVSs to which the current sample entry description is applied, and the value of picture_height should be equal to a value of vps_ols_dpb_pic_height[MultiLayerOlsIdx[output_layer_set_idx]].

Meanwhile, other important format information used in the VVC video elementary stream, and explicit indication for a chroma format and a bit depth may be provided by the VVC decoder configuration record. When color space or bit depth indications are different in VUI information of two sequences, two different VVC sample entries may also be required.

Further, a set of arrays that forward initialization non-VCL NAL units may exist in the VVC decoder configuration record. The NAL unit types may be restricted to display only the DCI, OPI, VPS, SPS, PPS, prefix APS, and prefix SEI NAL units. The NAL unit type reserved in ISO/IEC 23090-3 and the present disclosure may be defined in the future, and the reader may be required to ignore arrays having a reserved or unpermitted value of the NAL unit type.

Meanwhile, the NAL unit forward in the sample entry may be included just next to the AUD and OPI NAL units (if it exists) or included in a starting part of an access unit reconstructed from a first sample which refers to the sample entry.

Further, the arrays are recommended in the order of DCI, OPI, VPS, SPS, PPS, prefix APS, and prefix SEI.

The syntaxes of the VvcPTLRecord and the VVC decoder configuration record may be as in Tables 5 and 6 below.

TABLE 5

```
aligned(8) class VvcPTLRecord(num_sublayers) {
  bit(2) reserved = 0;
  unsigned int(6) num_bytes_constraint_info;
  unsigned int(7) general_profile_idc;
  unsigned int(1) general_tier_flag;
  unsigned int(8) general_level_idc;
  unsigned int(1) ptl_frame_only_constraint_flag;
  unsigned int(1) ptl_multilayer_enabled_flag;
  unsigned int(8*num_bytes_constraint_info − 2)
  general_constraint_info;
  for (i=num_sublayers − 2; i >= 0; i−−)
    unsigned int(1) ptl_sublayer_level_present_flag[i];
  for (j=num_sublayers; j<=8 && num_sublayers > 1; j++)
    bit(1) ptl_reserved_zero_bit = 0;
  for (i=num_sublayers−2; i >= 0; i−−)
    if (ptl_sublayer_level_present[i])
      unsigned int(8) sublayer_level_idc[i];
  unsigned int(8) num_sub_profiles;
  for (j=0; j < num_sub_profiles; j++)
    unsigned int(32) general_sub_profile_idc[j];
}
```

```
TABLE 6
aligned(8) class VvcDecoderConfigurationRecord {
  unsigned int(8) configurationversion = 1;
  bit(5) reserved = ‘11111’b;
  unsigned int(2) lengthSizeMinusOne;
  unsigned int(1) ptl_present_flag;
  if (ptl_present_flag) {
    unsigned int(16) output_layer_set_idx;
    unsigned int(16) avgFrameRate;
    unsigned int(2) constantFrameRate;
    unsigned int(3) numTemporalLayers;
    unsigned int(2) chroma_format_idc;
    unsigned int(3) bit depth minusB;
    bit(6) reserved = ‘111111’b; [Ed. (YK): Curently some reserved bits
have value 1 for each bit, and some reserved bits have value 0 for each
bit. Check whether it'd be better to have them in a consistent manner.]
    unsigned_int(16) picture_width;
    unsigned_int(16) picture_height;
    VvcPTLRecord(numTemporalLayers) track ptl;
  }
  unsigned int(8) numOfArrays;
  for (j=0; j < numOfArrays; j++) {
    unsigned int(1) array_completeness;
    bit(2) reserved = 0;
    unsigned int(5) NAL_unit_type;
    unsigned int(16) numNalus;
    for (i=0; i< numNalus; i++) {
      unsigned int(16) nalUnitLength;
      bit(8*nalUnitLenath) nalUnit;
    }
  }
)
```

Further, the semantics for the syntaxes of the VvcPTLRecord and the VVC decoder configuration record may be as in a table below.

```
TABLE 7
num_bytes_constraint_info is used to specify the length of the
  general_constraint_info field. The length of the
  general_constraint_info field is num_bytes_constraint_info * 8 − 2
  bits. The value shall be greater than 0. The value equal to 1 indicates that the
  gci_present_flag in the general_constraint_info( ) syntax structure represented by the
  general_constraint_info field is equal to 0.
general_profile_idc, general_tier_flag, general_level_idc,
  ptl_frame_only_constraint_flag, ptl_multilayer_enabled_flag,
  general_constraint_info, sublayer_level_present [ j ],
  sublayer_level_idc [ i ], num_sub_profiles, and
  general_sub_profile_idc [ j ] contain the matching values for the fields or syntax
  structures general_profile_idc, general_tier_flag, general_level_idc,
  ptl_frame_only_constraint_flag, ptl_multilayer_enabled_flag, general_constraint_info( ),
  ptl_sublayer_level_present[i], sublayer_level_idc[i], ptl_num_sub_profiles, and
  general_sub_profile_idc[j] as defined in ISO/IEC 23090-3, for the stream to which this
  configuration record applies.
lengthSizeMinusOne plus 1 indicates the length in bytes of the NALUnitLength field
  in a VVC video stream sample in the stream to which this configuration record applies. For
  example, a size of one byte is indicated with a value of 0. The value of this field shall be
  one of 0, 1, or 3 corresponding to a length encoded with 1, 2, or 4 bytes, respectively.
ptl_present_flag equal to 1 specifies that the track contains a VVC bitstream
  corresponding to the operating point specified by output_layer_set_idx and
  numTemporalLayers and all NAL units in the track belong to that operating point.
  ptl_present_flag equal to 0 specifies that the track may not contain a VVC bitstream
  corresponding to a specific operating point, but rather may contain a VVC bitstream
  corresponding to multiple output layer sets or may contain one or more individual layers
  that do not form an output layer set or individual sublayers excluding the sublayer with
  TemporalId equal to 0.
output_layer_set_idx specifies the output layer set index of an output layer set
  represented by the VVC bitstream contained in the track. The value of
  output_layer_set_idx may be used as the value of the TargetOlsIdx variable
  provided by external means or by an OPI NAL unit to the VVC decoder, as specified in
  ISO/IEC 23090-3, for decoding the bitstream contained in the track.
avgFrameRate gives the average frame rate in units of frames/(256 seconds), for the stream
  to which this configuration record applies. Value 0 indicates an unspecified average frame
  rate. When the track contains multiple layers and samples are reconstructed for the
  operating point specified by output_layer_set_idx and numTemporalLayers,
  this gives the average access unit rate of the bitstream of the operating point.
constantFrameRate equal to 1 indicates that the stream to which this configuration record
  applies is of constant frame rate. Value 2 indicates that the representation of each temporal
  layer in the stream is of constant frame rate. Value 0 indicates that the stream may or may
  not be of constant frame rate. When the track contains multiple layers and samples are
  reconstructed for the operating point specified by output_layer_set_idx and
  numTemporalLayers, this gives the indication of whether the bitstream of the
  operating point has constant access unit rate.
numTemporalLayers greater than 1 indicates that the track to which this configuration
  record applies is temporally scalable and the contained number of temporal layers (also
  referred to as temporal sublayer or sublayer in ISO/IEC 23090-3) is equal to
  numTemporalLayers. Value 1 indicates that the track to which this configuration record
  applies is not temporally scalable. Value 0 indicates that it is unknown whether the track
  to which this configuration record applies is temporally scalable.
chroma_format_idc indicates the chroma format that applies to this track.
bit_depth_minus8 indicates the bit depth that applies to this track.
picture_width indicates the maximum picture width, in units of luma samples, that
  applies to this track.
picture_height indicates the maximum picture height, in units of luma samples, that
  applies to this track.
track_ptl specifies the profile, tier, and level of the output layer set represented by the
  VVC bitstream contained in the track.
numArrays indicates the number of arrays of NAL units of the indicated type(s).
array_completeness when equal to 1 indicates that all NAL units of the given type are
  in the following array and none are in the stream; when equal to 0 indicates that additional
  NAL units of the indicated type may be in the stream; the permitted values are constrained
  by the sample entry name.
NAL_unit_type indicates the type of the NAL units in the following array (which shall be
  all of that type); it takes a value as defined in ISO/IEC 23090-3; it is restricted to take one
  of the values indicating a DCI, OPI, VPS, SPS, PPS, prefix APS or prefix SEI NAL unit.
numNalus indicates the number of NAL units of the indicated type included in the
  configuration record for the stream to which this configuration record applies. The SEI
  array shall only contain SEI messages of a ‘declarative’ nature, that is, those that provide
  information about the stream as a whole. An example of such an SEI could be a user-data
  SEI.
nalUnitLength indicates the length in bytes of the NAL unit.
nalUnit contains a DCI, OPI, VPS, SPS, PPS, APS or declarative SEI NAL unit, as specified in
  ISO/IEC 23090-3.
```

Meanwhile, the VVC file format defines various types of tracks as follows.

a) VVC track: The VVC track includes the NAL unit in the sample and the sample entry, and as a result, other VVC tracks including other sublayers of the VVC bitstream are referred to, and as a result, the VVC bitstream may be represented by referring to VVC subpicture tracks if possible.

b) VVC non-VCL track: may be stored in a track apart from a track including a different non-VCL NAL unit from ALF, LMCS, or APS s forwarding scaling list parameters, and transmitted therethrough. The track is the VVC non-VCL track.

c) VVC subpicture track: The subpicture track may include one of the followings.

Sequence of one or more VVC subpictures

Sequence of one or more complete slices forming a rectangular area

Meanwhile, the sample of the VVC subpicture track may include one of the followings.

One or more complete subpictures defined in ISO/IEC 23090-3 contiguous in decoding order

One or more complete slices forming the rectangular area and defined in ISO/IEC 23090-3 contiguous in decoding order

Meanwhile, the VVC subpicture or slice included in any sample of the VVC subpicture track may be contiguous in decoding order.

For example, the VVC non-VCL track and the VVC subpicture track may enable optimal delivery of a VVC video in a streaming application as follows. For example, each corresponding track may be delivered as a DASH representation thereof, and for decoding and rendering of a subset of the track, a DASH representation including the non-VCL track and a DASH representation including a subset of a VVC subpicture track may be requested by a client for each segment. By such a scheme, redundant transmission of APS and other non-VCL NAL units may be avoided.

Meanwhile, the VVC subpictures may be stored by various methods.

The VVC subpictures may be stored in various other ‘vvc1’/‘vvi1’or ‘vvs1’ tracks, i.e., the subpicture tracks. In other words, the VVC subpictures may be stored in various other ‘vvc1’/‘vvil’ or ‘vvs1’ tracks. The VVC subpictures stored in different VVC subpicture tracks may be merged in the single VVC bitstream based on a VVC merge base track referring to the VVC subpicture tracks or based on a subpicture entity group.

The VVC subpictures of the VVC bitstream may be stored in the single ‘vvc1’/‘vvi1’ track, and here, the subset of the VVC subpictures may be extracted to other VVC bitstreams based on a VVC extraction base track. For example, the ‘vvc1’/‘vvi1’ track may be the ‘vvc1’ track or the ‘vvi1’ track.

Meanwhile, since the VVC subpicture tracks may enable the VVC subpicture to be stored as separate tracks, any combination of the subpictures may be streamed or decoded. The VVC subpicture tracks may represent rectangular areas of the same video content as different bitrates or resolutions. Consequently, by selecting the streamed or decoded VVC subpicture tracks, a bitrate or resolution emphasis for the area may be dynamically adapted.

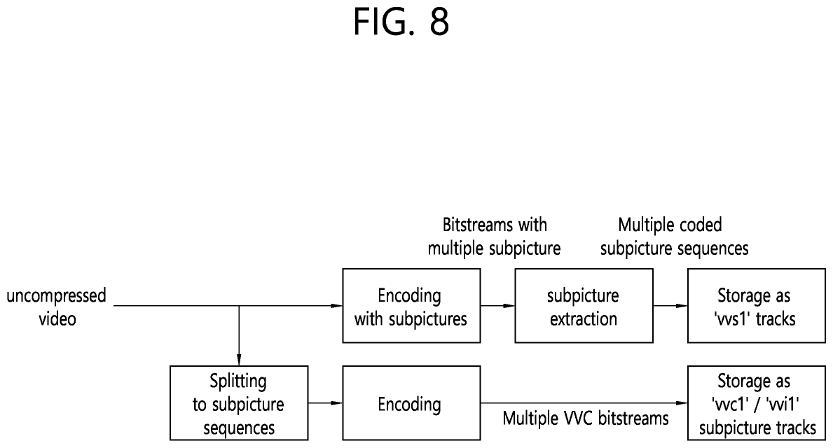

FIG. 8 schematically illustrates a method for generating VVC subpicture tracks.

According to FIG. 8, the VVC subpicture tracks may be generated by two following methods.

A wide content with multiple subpictures is encoded with the VVC bitstream, the subpictures coded from the VVC bitstream are extracted, and each of the extracted coded subpicture sequences is stored in as the ‘vvs1’ VVC subpicture track.

An uncompressed video is split into multiple uncompressed subpicture sequences before encoding, each of the multiple uncompressed subpicture sequences is encoded with the VVC bitstream, and each VVC bitstream is stored as the ‘vvc1’/‘vvi1’ track.

Further, it is possible to mix the methods for generating the VVC subpicture tracks. For example, after the coded subpictures are extracted, the extracted coded subpictures may be stored as the ‘vvc1’/‘vvi1 ’ tracks. In other words, after the coded subpictures are extracted, the extracted coded subpictures may be stored as the ‘vvc1’ track or the ‘vvi1’ track. In this case, some high-level syntax structures such as the parameter sets should be generated.

Meanwhile, the subpicture entity groups may be generated to represent a combination of the VVC subpicture tracks which may be merged as the VVC bitstream. Further, when the VVC subpicture tracks are merged as proposed by the subpicture entity group, the read needs to generate some high-level syntax structures such as the parameter sets.

Meanwhile, in order to reconstruct the access unit in samples of multiple tracks that deliver the multi-layer VVC bitstream, first, the operating point may be determined.

For example, when the VVC bitstream is represented as multiple VVC tracks, a file parser may identify tracks required for the operating point selected as below.

The VVC bitstream is selected based on the ‘opeg’ entity group and the ‘vvcb’ entity group, and the ‘vopi’ sample group.

Operating points suitable for decoding capacity and application purposes are selected from the ‘opeg’ entity group or the ‘vopi’ sample group.

When the ‘opeg’ entity group exists, the ‘opeg’ entity group may represent a set of tracks accurately representing the selected operating point. Accordingly, the VVC bitstream may be reconstructed and decoded from the set of the tracks.

When the ‘opeg’ entity group does not exist (i.e., when the ‘vopi’ sample group exists), a set of tracks required for decoding the selected operating point may be determined in the ‘vvcb’ entity group and the ‘vopi’ sample group.

For example, in order to reconstruct the bitstream from multiple VVC tracks that deliver the VVC bitstream, a target highest value of TemporallD may be required to be first determined.

For example, when a plurality of tracks includes data for the access unit, alignment of respective samples in the tracks may be performed based sample decoding times. That is, a time-to-sample table may be used without considering edit lists.

For example, when the VVC bitstream is represented as multiple VVC tracks, if the tracks are combined to a single stream by increasing the decoding time, the decoding time of the samples may be required to allow an access unit order to be accurate as specified in ISO/IEC 23090-3.

The sequence of the access units may be reconstructed from each sample of tracks required according to an implicit reconstruction process described as below.

Meanwhile, the implicit reconstruction process of the VVC bitstream may be as follows.

For example, when the operating points information sample group exists, the required tracks are selected based on layers delivered thereby and reference layers represented in the operating points information sample group.

Further, for example, when the operating point entity group exists, the required tracks may be selected based on information of OperatingPointGroupBox.

Further, for example, when the VCL NAL unit reconstructs a bitstream including a sublayer having Temporand larger than 0, all lower sublayers (i.e., sublayers in which the VCL NAL unit has smaller TemporalId) in the same layer are also be included in a resulting bitstream, and as a result, required tracks may be selected.

Further, for example, when the access unit is reconstructed, picture units (defined in ISO/IEC 23090-3) may be disposed in the access unit in increasing order of a nuh_layer_id value from samples having the same decoding time.

Further, for example, when at least one of multiple picture units for the access unit has an AUD NAL unit, a first picture unit (i.e., a picture unit having a smallest value of nuh_layer_id) should have the AUD NAL unit, and only the AUD NAL unit in the first picture unit is kept in the reconstructed access unit, while when other AUD NAL units exist, other AUD NAL units may be discarded. In the reconstructed access unit, when the AUD NAL unit has aud_irap_or_gdr_flag equal to 1 and the reconstructed access unit is not an IRAP or GDR access unit, the value of aud_irap_or_gdr_flag of the AUD NAL unit is set to be equal to 0.

The AUD NAL unit of a first PU may have aud_irap_orgdr_flag equal to 1, and another PU which is for the same access unit, but exists in a separate track may have a picture other than the IRAP or GDR picture. In this case, the value of aud_irap_or_gdr_flag of the AUD NAL unit which exists in the reconstructed access unit is changed from 1 to 0.

Further, for example, when the operating point entity group does not exist, a track which is selected among tracks delivering the same layer or sublayer, and finally required may collectively deliver some layers or sublayers which do not belong to a target operating point. The bitstream reconstructed for the target operating point is delivered in the finally required track, but should not include the layer or sublayer which does not belong to the target operating point.

In VVC decoder implementations, a target output layer set index and a bitstream corresponding to a highest Temporalld value of the target operating point corresponding to TargetOlsldX and HighestTid variables in Section 8 of ISO/IEC 23090-3, respectively are used as inputs. It should be confirmed whether the file parser does not include any other layer and sublayer other than the reconstructed bitstream being included in the target operating point before sending the reconstructed bitstream to the VVC decoder.

For example, when the access unit is reconstructed by dependent layers and max_tid_il_ref_pics_plus1 is larger than 0, only sublayers of reference layers for a VCL NAL unit having TemporalInd equal to or smaller than max_tid_il_ref_pics_plus1−1 (represented in the operating points information sample group) in the same layer are included in the resulting bitstream, and as a result, required tracks may be selected.

Further, for example, when the access unit is reconstructed with the dependent layers and max_tid_il_ref pics_plus1 is equal to 0, only an IRAP picture unit and a GDR picture unit having ph_recovery_poc_cnt equal to 0 are included in the resulting bitstream among all picture units of the reference layers, and as a result, the required tracks may be selected.

For example, when the VVC track includes the ‘subp’ track reference, each picture unit may be reconstructed as specified in Section 11.6.3 of ISO/IEC 23090-3 together with additional constraints for EOS and EOB NAL units specified below. A process in Section 11.6.3 of ISO/IEC 23090-3 may be repeated for each layer of the target operating point in increasing order of nuh_layer_id. Otherwise, each picture unit may be reconstructed as follows.

The reconstructed access unit may be disposed in the VVC bitstream in increasing order of the decoding time, and as additionally described below, duplicates of the end of bitstream (EOB) and end of sequence (EOS) NAL units may be removed from the VVC bistream.

For example, there may be one or more tracks including an EOS NAL unit having a specific nuh_layer_id value in each sample, for access units within the same coded video sequence of the VVCI bitstream and belonging to different sublayers stored in multiple tracks.

In this case, only one of the EOS NAL units may be kept in a last access unit (a unit having a largest decoding time) among the access units in the finally reconstructed bitstream, and may be disposed after all NAL units other than the EOB NAL unit (if it exists) of the last access unit among the access units and other EOS NAL units may be discarded. Similarly, there may be one or more tracks including the EOB NAL unit in each sample. In this case, only one of the

EOB NAL units may be kept in the finally reconstructed bitstream, and disposed in a last end of the access units and other EOB NAL units may be discarded.

Further, for example, since a specific layer or sublayer may be represented as one or more tracks, when required tracks are known for the operating point, the track may also be required to be selected from a set of tracks that deliver all of the specific layers or sublayers.

Meanwhile, the picture unit may be reconstructed in the sample of the VVC track referring to the VVC subpicture track.

For example, the sample of the VVC track may be resolved by a picture unit including the NAL unit to be described below in the following order.

When the picture unit exists in the sample, AUD NAL unit

For example, when the AUD NAL unit exists in the sample, a first NAL unit in the sample.

When the sample is a first sample of a sequence of samples related to the same sample entry, a parameter set and an SEI NAL unit included in the sample entry (if it exist).

When there is at least one NAL unit in which nal_unit_type in the sample is EOS_NUT, EOB_NUT, SUFFIX_APS_NUT, SUFFIX_SEI_NUT, FD_NUT, RSV_NVCL_27, UNSPEC_30, or UNSPEC_31 (the NAL unit of the NAL unit type may not be positioned before a first VCL NAL unit), NAL units in the ample except for a first unit among the NAL units and otherwise, all NAL units in the sample.

Contents resolved (within the decoding time), which are time-aligned in VVC subpicture tracks referred to, respectively in the order of VVC subpicture tracks referred to in the ‘subp’ track reference (when num_subpic_ref idx within the same group entry of the ‘spor’ sample group entry mapped to the sample is equal to 0). Alternatively, except for all DCI, OPI, VPS, SPS, PPS, AUD, PH, EOS, EOB, and other AU-level or picture-level non-VCL NAL units, contents (if it exists) resolved (within the decoding time), which are time-aligned in the VVC subpicture tracks referred to, respectively in an order specified in the ‘spor’ sample group description entry mapped to the sample. The track reference is resolved as specified below.

For example, when the referred VVC subpicture track is related to the VVC non-VCL track, a resolved sample of the VVC subpicture track includes the non-VCL NAL unit of the time-aligned sample in the VVC non-VCL track (if it exists).

- All NAL units in which the nal_unit_type is EOS_NUT, EOB_NUT, SUFFIX_APS_NUT, SUFFIX_SEI_NUT, FD_NUT, RSV_NVCL_27, UNSPEC_30, or UNSPEC_31.

Meanwhile, when num_subpic_ref_idx of the ‘spor’ sample group description entry mapped to the sample is equal to 0, each track reference in the ‘subp’ box may be resolved as follows. Otherwise, when each instance of the track reference subp_track_ref_idx num_subpic_ref_idx in the ‘spor’ sample group description entry mapped to the sample may be resolved as follows.

When the track reference indicates a track ID of the VVC subpicture track, the track reference may be resolved with the VVC subpicture track.

Otherwise (when the track reference indicates the ‘alte’ track group), the track reference may be resolved with one of any tracks of the ‘alte’ track group. In this case, when a specific track reference index value is resolved for a specific track in a previous sample, the track reference index value should be resolved with one of the followings in a current sample.

For example, the track reference index value may be resolved with the same specific track.

Alternatively, for example, the track reference index value may be resolved with any other track in the same ‘alte’ track group including a sync sample time-aligned with the current sample.

Further, since the VVC subpicture tracks in the same ‘alte’ track group need to be independent from any other VVC subpicture tracks referred to by the same VVC base track in order to avoid decoding mismatches.

For example, all VVC subpicture tracks include VVC subpictures.

Further, for example, subpicture boundaries are the same as picture boundaries.

Meanwhile, each sample of the VVC base track resolved in the ‘subp’ track reference may form a rectangular region without a hole and an overlap. A case where there is no hole means that all samples in the rectangular region should be covered. The overlap means that all samples in the rectangular region should be covered only once.

Meanwhile, when the reader selects a VVC subpicture track including a VVC subpicture having a set of different subpicture ID values from initial selection or previous selection, the following steps may be performed.

The ‘spor’ sample group description entry may be studied in order to determine whether the PPS or SPS NAL unit needs to be changed.

When the ‘spor’ sample group description entry represents whether start code emulation prevention bytes exist before or within subpicture IDs including the NAL unit, the RBSP is derived from the NAL unit (i.e., the start code emulation prevention bytes are removed). In a next step, after overriding, start code emulation prevention is performed again.

The reader uses subpicture ID length information and a bit position within the ‘spor’ sample group entry in order to determine which bits are overwritten to update the supicture ID to a selected subpicture ID.

When the subpicture ID value of the PPS or SPS is initially selected, the reader needs to write the PPS or SPS with each subpicture ID value selected in the reconstructed access unit.

- When the subpicture ID values of the PPS and the SPS are changed as compared with the previous PPS and SPS having the same PPS ID value or SPS ID value, respectively, the reader needs to include copies of the previous PPS and SPS (when each of the PPS or SPS having the same PPS or SPS ID value does not exist in the access unit) and needs to write the PPS and the SPS with the updated subpicture ID values of the reconstructed access unit, respectively.

When there is a ‘minp’ sample group description entry mapped to the sample of the

VVC base track, the following operations may be applied.

The ‘minp’ sample group description entry may be studied in order to determine a value of pps_mixed_nalu_types_in_pic_flag.

When the corresponding value is different from a value in the previous PPS NAL unit having the same PPS ID in the reconstructed bitstream.

For example, by the steps above, when the PPS is not included in the picture unit, the reader needs to include a copy of the PPS having the updated pps_mixed_nalu_types_in_pic_flag value in the reconstructed picture unit.

Further, for example, the reader uses the bit position in the ‘minp’ sample group entry in order to determine which bit is overwritten in order to update pps_mixed_nalu_types_in_pic_flag.

Meanwhile, a stream access point (SAP) sample group ‘sap’ defined in ISO/IEC 14496-12 is used for providing information on all SAPs.

For example, a semantic of layer_id_method_jdc equal to 0 is defined in ISO/IEC 14496-12. For example, when Layer_id_method_idc is equal to 0, the SAP is interpreted as follows.

When the sample entry type is ‘vvc1’ or ‘vvi1’ and the track does not include the sublayer in which Temporalld is 0, the SAP specifies an access to all sublayers which exist in the track.

Otherwise, the SAP specifies the access to all layers which exists in the track.

For example, when the sample entry type is ‘vvc1’ or ‘vviL’, and the track does not include any sublayer in which Temporalld is 0, an STSA picture having TemporallD which is the same as lowest Temporalld in the track serves as the SAP.

The GDR picture of the VVC bitstream is represented as SAP type 4 in the ‘sap’ sample group.

For example, VVC enables a sublayer having a different VCL_NAL unit type in the same coded picture. Gradual decoding refresh may be acquired by updating subpictures of respective subpicture indexes to IRAP subpictures within a range of the picture. However, the VVC does not specify a decoding process which starts in a picture having a mixed VCL NAL unit type.

Meanwhile, when all following matters are true,

the sample of the VVC track refers to PPS in which pps_mixed_nalu_types_in_pic_flag is 1, and

two following cases are true for each subpicture index i up to a range including sps_num_subpics_minusl from 0:

sps_subpic_treated_as_pic_flag[i] is equal to 1, and

there is at least one IRAP subpicture having the same subpicture index i or there is at least one IRAP subpicture following the current sample of the same CLVS,

the following is applied:

the sample may be represented as type 4 SAP sample, and

the sample may be mapped to a ‘roll’ sample group description entry. In this case, the ‘roll’ sample group description entry may have a correct roll_distance value for a decoding process of omitting decoding of subpictures having a specific subpicture index before the IRAP subpicture exists.

Further, when an SAP sample group is used, the SAP sample group should be used in all tracks that deliver the same VVC bitstream.

Meanwhile, a random access recovery point sample group ‘roll’ defined in ISO/IEC 14496-12 is used for providing information on recovery points for the gradual decoding refresh.

For example, the ‘roll’ sample group is used together with the VVC track, a syntax and a semantic of grouping_type_parameter may be defined equally to the ‘sap’ sample group of ISO/IEC 14496-12.

For example, layer_id_method_idc equal to 0 and 1 is used when a picture of a target layer of a sample mapped to the ‘roll’ sample group is the GDR picture.

For example, when layer_id_method_idc is equal to 0, the ‘roll’ sample group specifies behaviours of all layers which exist in the track.

A semantic of layer_id_method_idc equal to 1 is defined in Section 9.5.7.

For example, layer_id_method_idc equal to 2 and 3 is used when all pictures of the target layer of the sample mapped to the ‘roll’ sample group are not the GDR picture, and the following is applied to a picture of the target layer which is not the GDR picture.

The referred PPS has pps_mixed_nalu_types_in_pic_flag equal to 1, and

two following cases are true for each subpicture index i up to a range including sps_num_subpics_minusl from 0.

sps_subpic_treated_as_pic_flag[i] is equal to 1, and

there is at least one IRAP subpicture having the same subpicture index i or there is at least one IRAP subpicture following the current sample of the same CLVS.

For example, when layer_id_method_idc is equal to 2, the ‘roll’ sample group specifies behaviours of all layers which exist in the track.

For example, the semantic of layer_id_method_idc equal to 3 is defined in Section 9.5.7.

For example, when the reader uses samples marked with layer_id_method_idc equal to 2 and 3 in order to start decoding, the reader needs to additionally modify the SPS, PPS, and PH NAL units of the reconstructed bitstream as follows according to Section 11.6 so that a bitstream starting with a sample marked to belong to the sample group having layer_id_method_idc equal to 2 and 3 becomes a conforming bitstream.

Any SPS referred to by the sample has sps_gdr_enabled_flag equal to 1.

Any PPS referred to by the sample has pps_mixed_nalu_types_in_pic_flag equal to 0.

All VCL NAL units of the AU reconstructed from the sample have the same nal_unit_type as GDR_NUT.

Any picture header of the AU reconstructed from the sample has ph_gdr_pic_flag equal to 1 and a value of ph_recovery_poc_cnt corresponding to roll_distance of the ‘roll’ sample group description entry to which the sample is mapped.

Further, when the ‘roll’ sample group is concerned with the dependent layer, but is not a reference layer thereof, the sample group may represent applied when all reference layers of the dependent layer are available and decoded. Further, the sample group may be used for starting decoding of a predicted layer.

Meanwhile, in a current specification, the subpicture track may have sample entries ‘vvs1’, ‘vvc1’, and ‘vvil’, and there is a following difference.

When the VVC subpicture track includes a conforming VVC bitstream which may be consumed without other VVC subpicture track, a regular VVC sample entry (‘vvc1’ or ‘vvil’) may be used for the VVC subpicture track. Otherwise, the ‘vvsl’ sample entry is used for the VVC subpicture track, and the following constraint is applied.

A flag track_in_movie should be equal to 0.

The track should include only one sample entry.

The track should be referred to by at least one VVC base track through a track reference ‘subp’.

The DCI, OPI, VPS, SPS, PPS, AUD, PH, EOS, EOB, and other AU-level or picture-level non-VCL NAL units should not exist in both the samples of the sample entry and the ‘vvs1’ track.

Unless particularly specified, child boxes (e.g., CleanApertureBox and

PixelAspectRatioBox) of the video sample entry should not exist in the sample entry, and when the child boxes exist, the child boxes should be ignored.

Unless all VCL NAL units included in the sample do not observe sync sample requirements, the sample is not displayed as a sync sample.

Composition time offset information for the samples of the track ‘vvs1’ does not exist.

Subsample information for the sample of the track ‘vvs1’ may exist. When the subsample information exists, the subsample information should follow a definition of sub-samples for the VVC.

A noticeable difference between the subpicture track having the ‘vvs1’ sample entry ad the subpicture track having the ‘vvc1’ or ‘vvi1’ sample means that a case where the DCI, OPI, VPS, SPS, PPS, AUD, PH, EOX, EOB, and other AU-level or picture-level non-VCL NAL units should not exist in the sample entry and the samples of the ‘vvsl’ tracks. Such a constraint is not applied to the subpicture track having the ‘vvc1’ or ‘vvi1’ sample entry.

When the subpicture is referred to by at least one VVC base track, it may be beneficial to apply the same constraint to any subpicture tracks regardless of the sample entry type.

Therefore, the present disclosure proposes a solution for the problem. The proposed embodiments may be applied individually or combinationally.

As an example, when track A which is the track is referred to by track B which is another track by the ‘subp’ track reference, track A is the subpicture track and track B is the VVC base track regardless of the sample entry type which may be ‘vvs1’, ‘vvc1’, or ‘vvi1’.

Further, as an example, the DCI, OPI, VPS, SPS, PPS, AUD, PH, EOS, EOB, and other AU-level or picture-level non-VAL NAL units should not have the corresponding sample entry and the corresponding samples regardless of the sample entry type of the corresponding subpicture track.

Further, as an example, in another alternative, the DCI, OPI, VPS, SPS, PPS, AUD, PH, EOS, EOB, and other AU-level or picture-level non-VCL NAL units should not exist in both the samples of the corresponding sample entry and subsequent tracks.

‘vvs1’ track

‘vvi1 ’ track referred to by at least one VVC base track

‘vvc1’ track referred to by at least one VVC base track

As an example, when the VVC subpicture track includes a conforming VVC bitstream which may be consumed without other VVC subpicture track, a regular VVC sample entry (‘vvc1’ or ‘vvi1’) may be used for the VVC subpicture track. Otherwise, the ‘vvs1’ sample entry is used for the VVC subpicture track.

For example, the track having the ‘vvc1’ or ‘vvi1’ sample entry referred to by at least one VVC base track is the subpicture track.

For example, the following constraint is applied to the subpicture track having the ‘vvs1’ sample entry.

A flag track_in_movie should be equal to 0.

The track should include only one sample entry.

The track should be referred to by at least one VVC base track through a track reference ‘subp’.

Unless particularly specified, child boxes (e.g., CleanApertureBox and PixelAspectRatioBox) of the video sample entry should not exist in the sample entry, and when the child boxes exist, the child boxes should be ignored.

Unless all VCL NAL units included in the sample do not observe sync sample requirements, the sample is not displayed as a sync sample.

Composition time offset information for the samples of the track ‘vvs1’ does not exist.

Subsample information for the sample of the track ‘vvs1’ may exist. When the subsample information exists, the subsample information should follow a definition of sub-samples for the VVC.

For example, the following constraint is applied to the subpicture track regardless of the sample entry type.

The DCI, OPI, VPS, SPS, PPS, AUD, PH, EOS, EOB, and other AU-level or picture-level non-VCL NAL units should not exist in both the samples of the sample entry and the corresponding tracks.

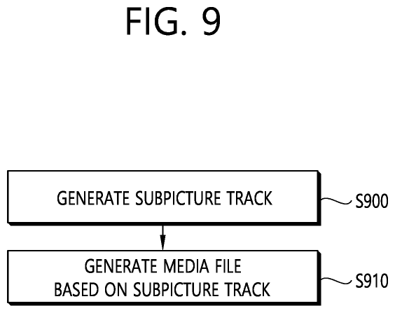

FIG. 9 exemplarily illustrates a method for generating a media file to which an embodiment proposed in the present disclosure is applied.

Referring to FIG. 9, a first device may generate a subpicture track (S900). For example, the first device may generate the subpicture track according to the embodiment. For example, the first device may represent a transmission end, an encoding end, or a media file generating end. Further, for example, the subpicture track may include a sample entry. Further, for example, the subpicture track may include samples. Further, the first device may include an encoder.

The first device may generate a media file based on the subpicture track (S910). For example, the first device may generate the media file based on the subpicture track according to the embodiment.

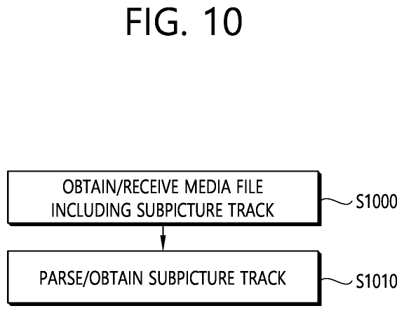

FIG. 10 exemplarily illustrates a method for decoding a media file generated by applying the embodiment proposed in the present disclosure.

Referring to FIG. 10, a second device may obtain/receive the media file including the subpicture track (S1000). For example, the second device may obtain/receive the media file including the subpicture track according to the embodiment. Further, for example, the second device may represent a reception end, a decoding end, or a rendering end.

For example, the media file may include information described in Table 1 and/or 3.

The second device may parse/obtain the subpicture track (S1010). For example, the second device may parse/obtain the subpicture track included in the media file. Further, for example, the subpicture track may include a sample entry. Further, for example, the subpicture track may include samples.

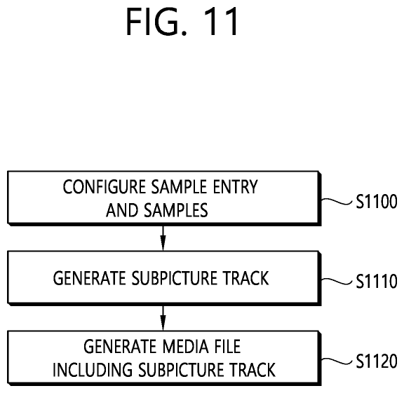

FIG. 11 schematically illustrates a method for generating a media file by an apparatus for generating a media file according to the present disclosure. The method disclosed in FIG.

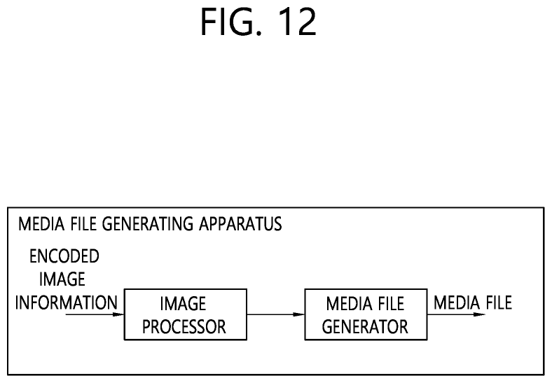

11 may be performed by an apparatus for generating a media file disclosed in FIG. 12. The media file generating apparatus may represent the first device. Specifically, for example, S1100 to S1110 of FIG. 11 may be performed by an image processor of the media file generating apparatus, and S1120 may be performed by a media file generator of the media file generating apparatus. Further, although not illustrated, a process of encoding a bitstream including image information may be performed by an encoder. The encoder may be included in the media file generating apparatus or constituted by an external component.

The media file generating apparatus constitutes a sample entry and samples (S1100). For example, the media file generating apparatus may constitute a sample entry and samples for a subpicture track. Further, for example, a sample entry type of the sample entry may be one of a ‘vvs1’, a ‘vvc1’, or ‘vvi1’.

The media file generating apparatus generates a subpicture track (S1110). For example, the media file generating apparatus may generate the subpicture track. Further, for example, the subpicture track may include the sample entry. Further, for example, the subpicture track may include the samples. Further, for example, the subpicture track may include the sample entry and the samples.

For example, the sample entry type of the sample entry may be one of ‘vvs1’, ‘vvc1’, or ‘vvi1’.

For example, the sample entry and the samples of the subpicture track may be configured without non-video coding layer (non-VCL) network abstraction layer (NAL) units.

For example, the sample entry and the samples of the subpicture track may be configured without the non-VCL NAL units based on the subpicture track including the sample entry in which the sample entry type is the ‘vvc1’ or the ‘vvi1’.

For example, the subpicture track may include the sample entry in which the sample entry type is the ‘vvc1’ or the ‘vvi1’ based on the subpicture track including a conforming versatile video coding (VVC) bitstream.

For example, the sample entry and the samples of the subpicture track may be configured without the non-VCL NAL units regardless of the sample entry type.

For example, the non-VCL NAL units may include decoding capability information (DCI), operating point information (OPI), video parameter set (VPS), sequence parameter set

(SPS), picture parameter set (PPS), access unit delimiter (AUD), picture header (PH), end of sequence (EOS), and end of bitstream (EOB) NAL units. Further, for example, the non-VCL NAL units may further include access unit-level (AU-level) or picture-level non-VCL NAL units.

For example, based on the case where the sample entry type is the ‘vvi1’, the subpicture track may include only one sample entry and the subpicture track may be referred to from at least one base track. Further, for example, the sample entry and the samples of the subpicture track may be configured without the non-VCL NAL units based on the sample entry type being one of the ‘vvs1’, the ‘vvc1’, or the ‘vvi1’.

The media file generating apparatus generates a media file including a subpicture track (S1120). The media file generating apparatus may generate the media file including the subpicture track. For example, the subpicture track may include the sample entry. Further, for example, the subpicture track may include the samples. Further, for example, the subpicture track may include the sample entry and the samples.

The methods disclosed in FIG. 11 are described based on flowcharts as a series of steps or blocks, but the methods are not limited to the order of the steps of the present disclosure and any step may occur in a step or an order different from or simultaneously as the aforementioned step or order. That is, in other words, S1100 and S1110 may occur in the different order from the aforementioned order, may be implemented individually and implemented simultaneously.

Meanwhile, although not illustrated, the media file generating apparatus may store the generated media file in a (digital) storage medium or deliver the generated media file to a media file processing apparatus through a network or the (digital storage medium). Here, the network may include a broadcasting network and/or a communication network and the digital storage medium may include various storage media including USB, SD, CD, DVD, Blu-ray, HDD, SSD, and the like.

FIG. 12 schematically illustrates an apparatus for generating a media file, which performs a method for generating a media file according to the present disclosure. The method disclosed in FIG. 11 may be performed by an apparatus for generating a media file disclosed in FIG. 12. Specifically, for example, S1100 to S1110 may be performed by an image processor of the media file generating apparatus of FIGS. 12, and S1120 may be performed by a media file generator of the media file generating apparatus of FIG. 12. Further, although not illustrated, a process of encoding a bitstream including image information may be performed by an encoder of the media file generating apparatus.

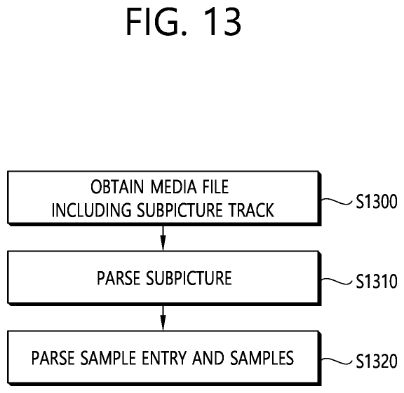

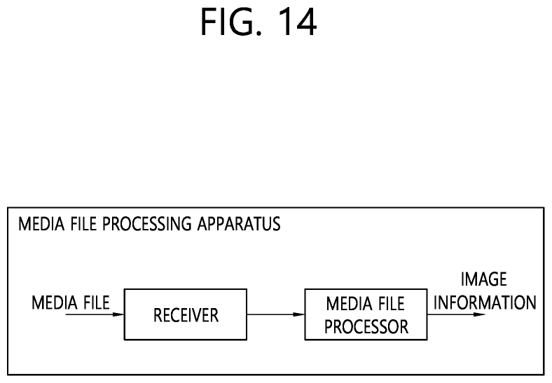

FIG. 13 schematically illustrates a method for processing a media file by an apparatus for processing a media file according to the present disclosure. The method disclosed in FIG. 13 may be performed by an apparatus for processing a media file disclosed in FIG. 14. The media file processing apparatus may represent the second device. As a specific example, S1300 of FIG. 13 may be performed by a receiver of the media file processing apparatus and S1310 to S1320 may be performed by a media file processor of the media file processing apparatus. Further, although not illustrated, a process of decoding the bitstream based on the track may be performed by a decoder. The decoder may be included in the media file processing apparatus or constituted by an external component.

The media file processing apparatus obtains a media file including a subpicture track (S1300). For example, the media file processing apparatus may obtain the media file including the subpicture track through the network or the (digital storage medium). Here, the network may include a broadcasting network and/or a communication network and the digital storage medium may include various storage media including USB, SD, CD, DVD, Blu-ray, HDD, SSD, and the like.

The media file processing apparatus parses the subpicture track (S1310). For example, the media file processing apparatus may parse/obtain the subpicture track. Further, for example, the subpicture track may include a sample entry. Further, for example, the subpicture track may include samples. Further, for example, the subpicture track may include the sample entry and the samples.

The media file processing apparatus parses the sample entry and the samples (S1320). For example, the media file processing apparatus may parse/obtain the sample entry and the samples for the subpicture track. Further, for example, a sample entry type of the sample entry may be one of a ‘vvs’, a ‘vvc1’, or ‘vvi1’.

For example, the sample entry and the samples of the subpicture track may be configured without non-video coding layer (non-VCL) network abstraction layer (NAL) units.

For example, the sample entry and the samples of the subpicture track may be configured without the non-VCL NAL units based on the subpicture track including the sample entry in which the sample entry type is the ‘vvc1’ or the ‘vvi1’.

For example, the subpicture track may include the sample entry in which the sample entry type is the ‘vvc1’ or the ‘vvi1’ based on the subpicture track including a conforming versatile video coding (VVC) bitstream.

For example, the sample entry and the samples of the subpicture track may be configured without the non-VCL NAL units regardless of the sample entry type.

For example, the non-VCL NAL units may include decoding capability information (DCI), operating point information (OPI), video parameter set (VPS), sequence parameter set (SPS), picture parameter set (PPS), access unit delimiter (AUD), picture header (PH), end of sequence (EOS), and end of bitstream (EOB) NAL units. Further, for example, the non-VCL NAL units may further include access unit-level (AU-level) or picture-level non-VCL NAL units.

For example, based on the case where the sample entry type is the ‘vvi1’, the subpicture track may include only one sample entry and the subpicture track may be referred to from at least one base track. Further, for example, the sample entry and the samples of the subpicture track may be configured without the non-VCL NAL units based on the sample entry type being one of the ‘vvs1’, the ‘vvc1’, or the ‘vvi1’.

The methods disclosed in FIG. 13 are described based on flowcharts as a series of steps or blocks, but the methods are not limited to the order of the steps of the present disclosure and any step may occur in a step or an order different from or simultaneously as the aforementioned step or order. In other words, S1310 and S1320 may occur in the different order from the aforementioned order, may be implemented individually and implemented simultaneously.

Meanwhile, although not illustrated, the media file processing apparatus may decode the bitstream based on the subpicture track. For example, the media file processing apparatus may decode image information in the bitstream for the subpicture track including the sample entry and the samples, and generate reconstructed samples based on the image information.

FIG. 14 schematically illustrates an apparatus for processing a media file, which performs a method for processing a media file according to the present disclosure. The method disclosed in FIG. 13 may be performed by an apparatus for processing a media file disclosed in FIG. 14. Specifically, for example, the receiver of the media file processing apparatus of FIG. 14 may perform S1300 of FIG. 13 and the media file processor of the media file processing apparatus of FIG. 14 may perform S1310 to S1320 of FIG. 13. Meanwhile, although not illustrated, the media file processing apparatus may include a decoder, and the decoder may decode the bitstream based on the subpicture track.

According to the present disclosure, a subpicture track includes a sample entry and samples, and a sample entry type of the sample entry is one of a ‘vvs1’, a ‘vvc1’, or a ‘vvi1’, and the sample entry and the samples of the subpicture track are configured without non-VCL NAL units. The non-VCL NAL unit is configured not to exist in the samples of the sample entry and the subpicture track regardless of the type of the sample entry in the subpicture track through this to implement a parser without considering the sample entry type in the subpicture track, thereby reducing complexity and increasing a processing speed.

In the above-described embodiment, the methods are described based on the flowchart having a series of steps or blocks. The present disclosure is not limited to the order of the above steps or blocks. Some steps or blocks may occur simultaneously or in a different order from other steps or blocks as described above. Further, those skilled in the art will understand that the steps shown in the above flowchart are not exclusive, that further steps may be included, or that one or more steps in the flowchart may be deleted without affecting the scope of the present disclosure.

The embodiments described in this specification may be performed by being implemented on a processor, a microprocessor, a controller or a chip. For example, the functional units shown in each drawing may be performed by being implemented on a computer, a processor, a microprocessor, a controller or a chip. In this case, information for implementation (e.g., information on instructions) or algorithm may be stored in a digital storage medium.

In addition, the apparatus to which the present disclosure is applied may be included in a multimedia broadcasting transmission/reception apparatus, a mobile communication terminal, a home cinema video apparatus, a digital cinema video apparatus, a surveillance camera, a video chatting apparatus, a real-time communication apparatus such as video communication, a mobile streaming apparatus, a storage medium, a camcorder, a VOD service providing apparatus, an Over the top (OTT) video apparatus, an Internet streaming service providing apparatus, a three-dimensional (3D) video apparatus, a virtual reality (VR) apparatus, an augmented reality (AR) apparatus, a teleconference video apparatus, a transportation user equipment (e.g., vehicle user equipment, an airplane user equipment, a ship user equipment, etc.) and a medical video apparatus and may be used to process video signals and data signals.

For example, the Over the top (OTT) video apparatus may include a game console, a blue-ray player, an internet access TV, a home theater system, a smart phone, a tablet PC, a Digital Video Recorder (DVR), and the like.

Furthermore, the processing method to which the present disclosure is applied may be produced in the form of a program that is to be executed by a computer and may be stored in a computer-readable recording medium. Multimedia data having a data structure according to the present disclosure may also be stored in computer-readable recording media. The computer-readable recording media include all types of storage devices in which data readable by a computer system is stored. The computer-readable recording media may include a BD, a Universal Serial Bus (USB), ROM, PROM, EPROM, EEPROM, RAM, CD-ROM, a magnetic tape, a floppy disk, and an optical data storage device, for example. Furthermore, the computer-readable recording media includes media implemented in the form of carrier waves (e.g., transmission through the Internet). In addition, a bit stream generated by the encoding method may be stored in a computer-readable recording medium or may be transmitted over wired/wireless communication networks.

In addition, the embodiments of the present disclosure may be implemented with a computer program product according to program codes, and the program codes may be performed in a computer by the embodiments of the present disclosure. The program codes may be stored on a carrier which is readable by a computer.

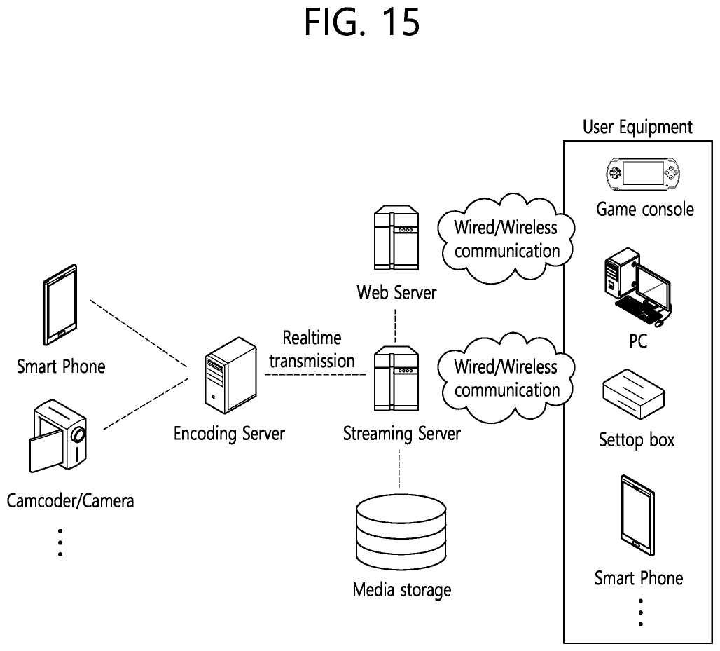

FIG. 15 illustrates a structural diagram of a contents streaming system to which the present disclosure is applied.

The content streaming system to which the embodiment(s) of the present disclosure is applied may largely include an encoding server, a streaming server, a web server, a media storage, a user device, and a multimedia input device.

The encoding server compresses content input from multimedia input devices such as a smartphone, a camera, a camcorder, etc. Into digital data to generate a bitstream and transmit the bitstream to the streaming server. As another example, when the multimedia input devices such as smartphones, cameras, camcorders, etc. directly generate a bitstream, the encoding server may be omitted.

The bitstream may be generated by an encoding method or a bitstream generating method to which the embodiment(s) of the present disclosure is applied, and the streaming server may temporarily store the bitstream in the process of transmitting or receiving the bitstream.

The streaming server transmits the multimedia data to the user device based on a user's request through the web server, and the web server serves as a medium for informing the user of a service. When the user requests a desired service from the web server, the web server delivers it to a streaming server, and the streaming server transmits multimedia data to the user. In this case, the content streaming system may include a separate control server. In this case, the control server serves to control a command/response between devices in the content streaming system.

The streaming server may receive content from a media storage and/or an encoding server. For example, when the content is received from the encoding server, the content may be received in real time. In this case, in order to provide a smooth streaming service, the streaming server may store the bitstream for a predetermined time.

Examples of the user device may include a mobile phone, a smartphone, a laptop computer, a digital broadcasting terminal, a personal digital assistant (PDA), a portable multimedia player (PMP), navigation, a slate PC, tablet PCs, ultrabooks, wearable devices (ex. Smartwatches, smart glasses, head mounted displays), digital TVs, desktops computer, digital signage, and the like. Each server in the content streaming system may be operated as a distributed server, in which case data received from each server may be distributed.

The claims described in the present disclosure may be combined in various ways. For example, the technical features of the method claims of the present disclosure may be combined to be implemented as an apparatus, and the technical features of the apparatus claims of the present disclosure may be combined to be implemented as a method. In addition, the technical features of the method claim of the present disclosure and the technical features of the apparatus claim may be combined to be implemented as an apparatus, and the technical features of the method claim of the present disclosure and the technical features of the apparatus claim may be combined to be implemented as a method.

What is claimed is:

1. A method for generating a media file, the method comprising:
configuring a sample entry and samples for a subpicture track;
generating the subpicture track comprising the sample entry and the samples; and
generating the media file comprising the subpicture track, wherein a sample entry type of the sample entry is one of a ‘vvs1’, a ‘vvc1’ or a ‘vvil’, and
wherein the sample entry and the samples in the subpicture track are configured without non-video coding layer (non-VCL) network abstraction layer (NAL) units.

2. The method of claim 1, wherein based on the subpicture track comprising the sample entry of which the sample entry type is the ‘vvc’ or the ‘vvil’, the sample entry and the samples in the subpicture track are configured without the non-VCL NAL units.

3. The method of claim 1, wherein based on the subpicture track containing a conforming VVC bitstream, the subpicture track comprises the sample entry of which the sample entry type is the ‘vvc’ or the ‘vvil’.

4. The method of claim 1, wherein the sample entry and the samples in the subpicture track are configured without the non-VCL NAL units regardless of the sample entry type.

5. The method of claim 1, wherein the non-VCL NAL units include decoding capability information (DCI), operating point information (OPI), video parameter set (VPS), sequence parameter set (SPS), picture parameter set (PPS), access unit delimiter (AUD), picture header (PH), end of sequence (EOS), and end of bitstream (EOB) NAL units.

6. The method of claim 5, wherein the non-VCL NAL units further include access unit-level (AU-level) or picture-level non-VCL NAL units.f

7. The method of claim 1, wherein based on the sample entry type being the ‘vvs1’, the subpicture track contains only one sample entry and the subpicture track is referenced by at least one base track, and
wherein based on the sample entry type being one of the ‘vvs1’, the ‘vvc1’ or the ‘vvi1’, the sample entry and the samples in the subpicture track are configured without the non-VCL NAL units.

8. A media file generating device for generating a media file generated by a method of a media file generating of claim 1.

9. A method for processing a media file, the method comprising:
obtaining the media file comprising a subpicture track comprising a sample entry and samples;
parsing the subpicture track; and
parsing the sample entry and the samples for the subpicture track;
wherein a sample entry type of the sample entry is one of a ‘vvs1’, a ‘vvc1’ or a ‘vvi1’, and
wherein the sample entry and the samples in the subpicture track are configured without non-video coding layer (non-VCL) network abstraction layer (NAL) units.

10. The method of claim 9, wherein based on the subpicture track comprising the sample entry in which the sample entry type is the ‘vvc1’ or the ‘vvi1’, the sample entry and the samples in the subpicture track are configured without the non-VCL NAL units.

11. The method of claim 9, wherein based on the subpicture track containing a conforming VVC bitstream, the subpicture track comprises the sample entry of which the sample entry type is the ‘vvc1’ or the ‘vvi1’.

12. The method of claim 9, wherein the sample entry and the samples in the subpicture track are configured without the non-VCL NAL units regardless of the sample entry type.

13. The method of claim 9, wherein the non-VCL NAL units include decoding capability information (DCI), operating point information (OPI), video parameter set (VPS), sequence parameter set (SPS), picture parameter set (PPS), access unit delimiter (AUD), picture header (PH), end of sequence (EOS), and end of bitstream (EOB) NAL units.

14. The method of claim 13, wherein the non-VCL NAL units further include access unit-level (AU-level) or picture-level non-VCL NAL units.

15. The method of claim 9, wherein based on the sample entry type being the ‘vvs1’, the subpicture track contains only one sample entry and the subpicture track is referenced by at least one base track, and wherein based on the sample entry type being one of the ‘vvs1’, the ‘vvc1’ or the ‘vvi1’, the sample entry and the samples in the subpicture track are configured without the non-VCL NAL units.

16. An apparatus for processing a media file, which processes a media file by performing the method for processing a media file of claim 9.
